(19) United States
(12) Patent Application Publication
(10) Pub. No.: US 2022/0203801 A1
(43) Pub. Date: Jun. 30, 2022

(54) LAND VEHICLE

(71) Applicant: Mario Rolando NAVARRETE, AREZZO (IT)

(72) Inventor: Mario Rolando NAVARRETE, AREZZO (IT)

(21) Appl. No.: 17/613,010

(22) PCT Filed: May 22, 2020
(86) PCT No.: PCT/IB2020/054877

§ 371 Date: Nov. 19, 2021

(30) Foreign Application Priority Data
May 22, 2019 (IT) 102019000007121
May 22, 2019 (IT) 102019000007126
May 22, 2019 (IT) 102019000007129
May 22, 2019 (IT) 102019000007132

(51) Int. Cl. B60G 21/067; B60G 21/073

(52) U.S. Cl. CPC B60G 21/067; B60G 21/073; B60G 2800/014; B60G 2600/68; B60G 2800/912; B60G 2204/8304

(57) ABSTRACT

Land vehicle provided with a frame; four wheels; and four compensation systems each associated with a respective wheel. The vehicle is also provided with a control unit, in particular a hydraulic control unit, which has compensation systems and connects each wheel to the other wheels. The vehicle has a plurality of hydraulic filters, which are each arranged between a wheel and the respective compensation system; the hydraulic filters are low-pass filters designed to reduce (in particular stop), in case of undesired frequencies, the flow of a transmission fluid and, hence, the association between the wheel and the respective compensation system.

### CROSS-REFERENCE TO RELATED APPLICATIONS

This patent application claims priority from Italian patent applications no. 102019000007126 filed on 22 May 2019, no. 102019000007129 filed on 22 May 2019, no. 102019000007131 filed on 22 May 2019 and no. 102019000007132 filed on 22 May 2019, the entire disclosure of which is incorporated herein by reference.

### TECHNICAL FIELD

The present invention relates to a land vehicle.

### BACKGROUND ART

In the industry of the land vehicles (i.e. those moving on a terrain) provided with wheels for the transport of things or people, ensuring the safety of the load and the comfort of passengers is becoming increasingly important. Such vehicles are generally also provided with a frame.

Normally, when crossing uneven terrains (for example streams, unpaved or paved roads, etc.), the safety and comfort of passengers together with the structural solidity of the land vehicle risk being compromised, since the roughness of the terrain causes a misalignment of the wheels with respect to their natural position (level).

Due to the roll and the pitch thus obtained, an incorrect distribution of forces is observed, reducing the stability of the vehicle (one or more wheels may lose load and therefore adherence to the terrain).

In the event that the land vehicle is an electric wheelchair, it is usually not possible to travel on it on uneven or sloping terrains, as it is not possible to go up or down steps. This is because some wheels of the wheelchair lose contact with the ground, in particular they transmit torsional forces to the frame of the wheelchair, and in most cases they risk blocking or dropping those on board thereof. In the event that the land vehicle is an automobile, the torsions undergone by the frame when travelling on uneven terrains causes the frame to react elastically generating oscillations, which cause a loss of adherence and cause instability, generating jolts that tend to undermine the stability of the vehicle.

Furthermore, in the particular case of high-performance sports cars, the torsions caused on the frame (for example by a curb during a race) generate a variation in the load distribution and therefore a loss of performance.

In order to decrease the transmission of torsional forces from the wheels to the frame, increasingly softer and damping suspensions have been produced, which, however, in order to mitigate the roughness of the terrain, increase the roll and/or pitch phenomena of the vehicle. However, said suspensions usually act on the wheels independently of one another or in any case not synergistically for all the wheels of the vehicle; consequently, although reduced, the torsional forces are still transmitted to the frame, generating the drawbacks described above.

In some cases, for example as described in documents DE 19606364, U.S. Pat. Nos. 5,269,556 and 5,915,701, the suspensions are connected to one another by using ducts provided with accumulators, in particular hydraulic accumulators, which however cause a softening of the suspensions themselves and, while travelling on uneven terrains, they generate an increase in roll and pitch, undermining the comfort and performance of the vehicle.

In other cases, such as the one described in document US 2004169345, each wheel is connected to multiple suspension systems, which, however, also act as anti-roll bars and therefore hinder the adaptation of the wheels to the non-planarity (therefore to the roughness) of the terrain, generating torsions on the vehicle frame and undermining the stability thereof.

The object of the present invention is that of providing a land vehicle which is free from the drawbacks described above and, at the same time, is simple and inexpensive to manufacture.

### SUMMARY

In accordance with the present invention, a land vehicle is provided according to what is cited in the independent claims that follow and, preferably, in any of the claims directly or indirectly dependent on the independent claims.

### BRIEF DESCRIPTION OF THE DRAWINGS

The present invention will now be described with reference to the accompanying drawings, which illustrate some non-limiting examples of embodiments, in which:

FIG. 1 schematically illustrates the structure of a first embodiment of a land vehicle according to the present invention and provided with four wheels, in which hydraulic cylinders have a series configuration;

FIG. 2 schematically illustrates the structure of a second embodiment according to the present invention of a land vehicle provided with four wheels, in which hydraulic cylinders have a concentric configuration;

FIG. 3 schematically illustrates the structure of a third embodiment according to the present invention of a land vehicle provided with four wheels, in which there are no transmission cylinders;

FIG. 4 schematically illustrates the structure of a fourth embodiment according to the present invention of a land vehicle, in which there are eight wheels;

FIG. 5 schematically illustrates the structure of a fifth embodiment according to the present invention of a land vehicle provided with four wheels, in which hydraulic cylinders have a concentric configuration;

FIG. 6 schematically illustrates the structure of a sixth embodiment according to the present invention of a land vehicle provided with four wheels, to which respective movable cylinders are connected;

FIG. 7 schematically illustrates the structure of a seventh embodiment according to the present invention of a land vehicle provided with four wheels, in which a suspension 24 is interposed between hydraulic cylinders of different compensation systems;

FIG. 8 schematically illustrates the structure of an eighth embodiment according to the present invention of a vehicle provided with hydraulic filters and viscous dampers;

FIG. 9 schematically illustrates the structure of a ninth embodiment according to the present invention of a vehicle provided with hydraulic filters, viscous dampers and a hydraulic pump;

FIG. 10 schematically illustrates the structure of a first embodiment of a hydraulic filter in a first disengagement position and mounted on a vehicle according to the present invention;

FIG. 11 schematically illustrates the hydraulic filter of FIG. 10 in a second disengagement position and mounted on a vehicle according to the present invention;

FIG. 12 schematically illustrates the hydraulic filter of FIG. 10 in a blocking position and mounted on a vehicle according to the present invention;

FIG. 13 schematically illustrates the structure of a second embodiment of a hydraulic filter in a disengagement position;

FIG. 14 schematically illustrates the hydraulic filter of FIG. 13 in a blocking position and mounted on a vehicle according to the present invention; and

FIG. 15 schematically illustrates the structure of a non-limiting embodiment of a viscous damper.

### BEST MODE FOR CARRYING OUT THE INVENTION

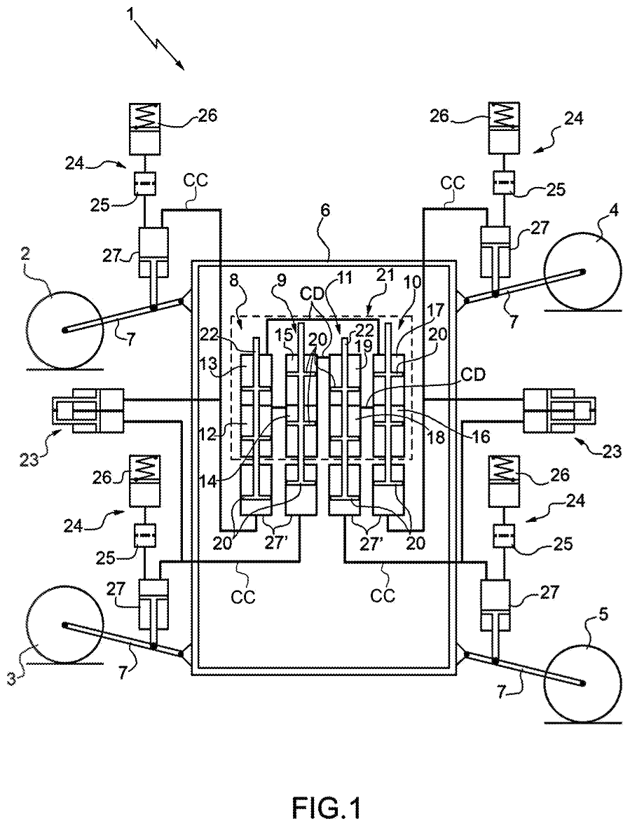

In FIG. 1, the number 1 indicates as a whole a land vehicle provided with (at least) four wheels 2, 3, 4 and 5, which, in particular, receive the driving torque from a motor (not shown), for example an electric motor or an internal combustion motor. The land vehicle 1 is provided with a frame 6, which is connected, in particular mechanically, to the wheels 2, 3, 4 and 5 through, for example, connection joints 7. In some cases, the frame 6 is directly connected to the wheels 2, 3, 4 and 5 through alternative mechanical connection systems (e.g. pistons of compensation and/or damping systems).

Furthermore, the land vehicle 1 comprises (at least) four compensation systems 8, 9, 10 and 11, which are each associated to a respective wheel 2, 3, 4 and 5.

Each compensation system 8, 9, 10 and 11 comprises at least two cylinders, in particular connected to one another. More precisely, the compensation system 8 comprises the hydraulic cylinders 12 and 13, the compensation system 9 comprises the hydraulic cylinders 14 and 15, the compensation system 10 comprises the hydraulic cylinders 16 and 17, the compensation system 11 comprises the hydraulic cylinders 18 and 19. In particular, each compensation system 8, 9, 10 and 11 is provided with at least two respective pistons 20 (each arranged inside a relative cylinder 12, 13, 14, 15, 16, 17, 18 and 19).

More specifically, each cylinder 12, 13, 14, 15, 16, 17, 18 and 19 and the relative piston 20 arranged inside the cylinder 12, 13, 14, 15, 16, 17, 18 and 19 are mounted so that they can move relative to one another.

One (at least) between each cylinder 12, 13, 14, 15, 16, 17, 18 and 19 and the relative piston 20 is connected to the wheel 2, 3, 4 and 5 associated with the respective compensation system 8, 9, 10 and 11 so as to move depending on the variation of the position of said wheel 2, 3, 4 and 5 relative to the frame 6.

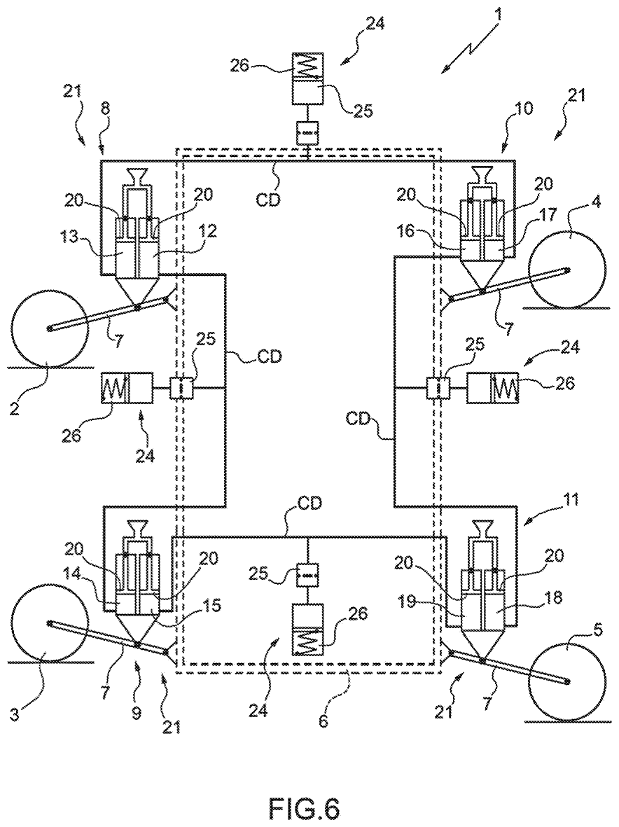

According to some specific and non-limiting embodiments (for example see FIG. 6), each cylinder 12, 13, 14, 15, 16, 17, 18 and 19 is movable and connected to the wheel 2, 3, 4 and 5 associated with the respective compensation system 8, 9, 10 and 11 so as to move depending on the variation of the position of said wheel 2, 3, 4 and 5 relative to the frame 6. More precisely, in these cases, the pistons 20 are substantially stationary (i.e. integral) relative to the frame 6.

According to some further specific and non-limiting embodiments (for example see FIGS. 1-5 and 7), each piston 20 is connected to the wheel 2, 3, 4 and 5 associated with the respective compensation system 8, 9, 10 and 11, so as to move depending on the variation of the position of said wheel 2, 3, 4 and 5 relative to the frame 6. More precisely, in these cases, the cylinders 12, 13, 14, 15, 16, 17, 18 and 19 are substantially stationary relative to the frame 6.

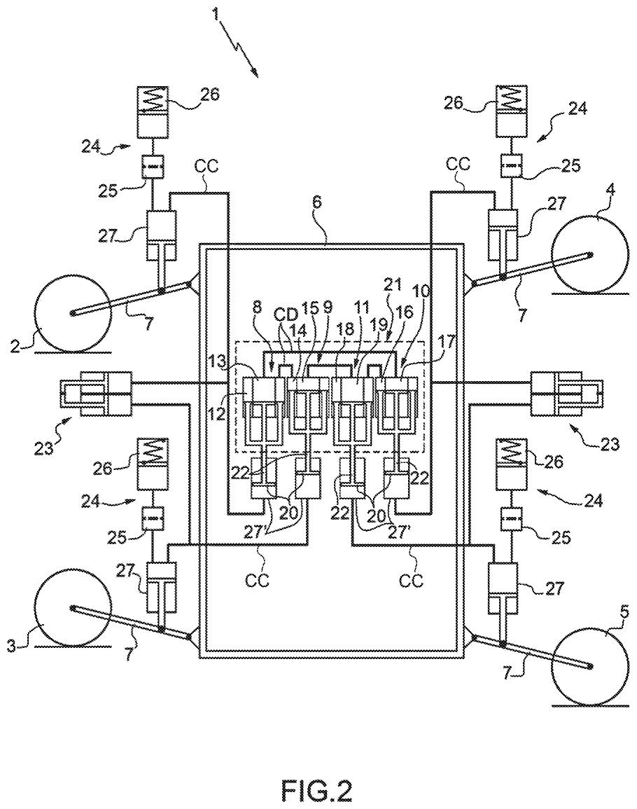

According to the non-limiting embodiment of FIGS. 1 and 2: the wheel 2 is associated with the compensation system 8; the wheel 3 is associated with the compensation system 9; the wheel 4 is associated with the compensation system 10; and the wheel 5 is associated with the compensation system 11.

In particular, each piston 20 moves in relation to the position of the respective wheel 2, 3, 4 and 5 along a predefined axis. In some cases, said predefined axis is perpendicular to the ground on which the land vehicle 1 is located.

The land vehicle 1 also comprises a control unit 21, which comprises the compensation systems 8, 9, 10 and 11 and (fluidically) connects each wheel 2, 3, 4 and 5 to the other wheels 2, 3, 4 and 5 by means of the hydraulic cylinders 12, 13, 14, 15, 16, 17, 18 and 19 of the compensation systems 8, 9, 10 and 11.

According to some non-limiting embodiments, the control unit 21 is a hydraulic control unit. In this way, it is possible to take advantage of the immediate and safe response provided by the hydraulic cylinders with respect to an electronic control unit, whose reliability and efficiency are affected by the quality of the electronic components used.

According to some non-limiting embodiments, the control unit 21 is an electronic control unit, in particular a programmable electronic control unit. In this way, albeit at the expense of performance, it is possible to take advantage of the versatility of electronics and/or of the software. It is thus possible to adjust the gains or the delays based on the type of land vehicle that one intends to manufacture. Advantageously but not necessarily, the two hydraulic cylinders 12, 13, 14, 15, 16, 17, 18 and 19 belonging to a respective compensation system 8, 9, 10 and 11 are (fluidically) connected (directly), each, to a hydraulic cylinder 12, 13, 14, 15, 16, 17, 18 and 19 of a different respective compensation system 8, 9, 10 and 11.

In particular, as illustrated in the embodiments shown in FIGS. 1 and 2:

the hydraulic cylinder 12 of the compensation system 8 is (fluidically) directly connected (i.e. without the interposition of further hydraulic cylinders or other actuators), to the hydraulic cylinder 14 of the compensation system 9 (in other words, a connection duct CD extends from the cylinder 12 to the cylinder 14);

the hydraulic cylinder 13 of the compensation system 8 is (fluidically) directly connected to a hydraulic cylinder 17 of the compensation system 10 (in other words, a connection duct CD extends from the cylinder 13 to the cylinder 17);

the hydraulic cylinder 15 of the compensation system 9 is (fluidically) directly connected to a hydraulic cylinder 19 of the compensation system 11 (in other words, a connection duct CD extends from the cylinder 15 to the cylinder 19); and

the hydraulic cylinder 16 of the compensation system 10 is (fluidically) directly connected to a hydraulic cylinder 18 of the compensation system 11 (in other words, a connection duct CD extends from the cylinder 16 to the cylinder 18).

Advantageously, but not necessarily, the vehicle 1 (in particular the control unit 21) comprises a plurality of connection ducts CD, each of which fluidically (and directly) connects a respective hydraulic cylinder 12, 13, 14, 15, 16, 17, 18 and 19 belonging to a respective compensation system 8, 9, 10 and 11 to another hydraulic cylinder 12, 13, 14, 15, 16, 17, 18 and 19 of a different respective system 8, 9, 10 and 11. In other words, the two hydraulic cylinders 12, 13, 14, 15, 16, 17, 18 and 19 belonging to a respective compensation system 8, 9, 10 and 11 are (fluidically) connected, each, to a hydraulic cylinder 12, 13, 14, 15, 16, 17, 18 and 19 of a different respective compensation system 8, 9, 10 and 11 by means of a respective connection duct CD.

In particular, the term “directly” means without using one or more other compensation systems or further hydraulic cylinders or other actuators in general.

More precisely, each connection duct CD extends from a first hydraulic cylinder 12, 13, 14, 15, 16, 17, 18 and 19 belonging to a respective compensation system 8, 9, 10 and 11 to a second hydraulic cylinder 12, 13, 14, 15, 16, 17, 18 and 19 belonging to another respective compensation system 8, 9, 10 and 11.

In particular, each wheel 2, 3, 4, 5 is directly connected to a single respective compensation system 8, 9, 10, 11.

Advantageously but not necessarily, there are no accumulation devices (accumulators), in particular hydraulic accumulators between each wheel 2, 3, 4, 5 and the respective compensation system 8, 9, 10, 11 (or between two different compensation systems 8, 9, 10, 11). This avoids introducing an increase in roll and pitch due to the elasticity of the hydraulic accumulators. The term “accumulation devices” refers to devices designed to store discrete quantities of a fluid and to release it later.

According to the non-limiting embodiments illustrated in FIGS. 1 and 2, the wheel 2 is the right front wheel, the wheel 3 is the front left wheel, the wheel 4 is the right rear wheel and the wheel 5 is the left rear wheel. In particular, the wheels 2 and 4 are arranged on the same side of the vehicle 1, in particular on the right side of the vehicle 1, likewise the wheels 3 and 5 are arranged on the same side of the vehicle 1, in particular on the left side of the vehicle 1. Furthermore, the wheels 2 and 3 are arranged in the area of a front part of the vehicle (i.e. the wheels 2 and 3 are the front wheels), whereas the wheels 4 and 5 are arranged in the area of a rear part of the vehicle (i.e. the wheels 4 and 5 are the rear wheels).

According to some non-limiting and not illustrated embodiments, the wheels 2 and 3 are connected to one another by a front axle of the vehicle 1, whereas the wheels 4 and 5 are connected to one another by a rear axle of the vehicle 1.

Advantageously but not necessarily, the control unit 21 directly (i.e. without using one or more other compensation systems or further hydraulic cylinders or other actuators; in particular, with the sole interposition of one of the connection ducts CD) connects the compensation systems 8, 9, 10 and 11 of two of the wheels 2, 3, 4 and 5 arranged on the same side of the vehicle (right or left, or front or rear) and indirectly (i.e. through one or more other compensation systems) connects the compensation systems 8, 9, 10 and 11 of two of the opposite wheels 2, 3, 4 and 5.

“Opposite wheels” (diagonally) means two of the wheels 2, 3, 4 and 5 not arranged on the same side (right, left and front, rear) of the vehicle. In particular, “opposite wheels” (diagonally) means two of the wheels 2, 3, 4 and 5 arranged on opposite sides with respect to the centre of gravity of the vehicle.

In the non-limiting embodiments illustrated in FIGS. 1 and 2, the control unit 21 connects the wheel 2 directly to the wheel 3 and the wheel 4, as well as directly (i.e. without using one or more other compensation systems or, more precisely, further hydraulic cylinders or other actuators; in particular, with the sole interposition of one of the connection ducts CD possibly provided with relative suspensions 24) connects the wheel 5 to the wheel 3 and to the wheel 4. The control unit 21 then indirectly (i.e. through one or more compensation systems 8, 9, 10 and 11 associated with one or more other wheels) connects the compensation systems 8, 9, 10 and 11 of the wheel 2 to those of the wheel 5 and the compensation systems 8, 9, 10 and 11 of the wheel 3 to those of the wheel 4.

More precisely, the compensation system 8 of the wheel 2 and the compensation system 10 of the wheel 4 are directly connected to one another (i.e. without using another compensation system or, more precisely, further hydraulic cylinders or other actuators); the compensation system 8 of the wheel 2 and the compensation system 9 of the wheel 3 are directly connected to one another (i.e. without using another compensation system—or, more precisely, further hydraulic cylinders or other actuators); the compensation system 9 of the wheel 3 and the compensation system 11 of the wheel 5 are directly connected to one another (i.e. without using another compensation system or, more precisely, further hydraulic cylinders or other actuators); the compensation system 10 of the wheel 4 and the compensation system 11 of the wheel 5 are directly connected to one another (i.e. without using another compensation system—or, more precisely, further hydraulic cylinders or other actuators).

Consequently, the compensation system 8 of the wheel 2 and the compensation system 11 of the wheel 5 are indirectly connected to one another (i.e. with the interposition of the compensation systems 9 and 10 of the wheel 3 and of the wheel 4); the compensation system 9 of the wheel 3 and the compensation system 10 of the wheel 4 are indirectly connected to one another (i.e. with the interposition of the compensation systems 8 and 11 of the wheel 2 and of the wheel 5).

By way of example: in the event that the wheel 2 is subjected to a lowering action due, for example, to a pothole on a ground, the wheel 3 and the wheel 4 are subjected to a lifting action, while the wheel 5 is lowered, so as to balance the forces and eliminate the torsions that would be created on the frame 6. In particular, the wheels 3 and 4 are lifted and the wheel 5 is lowered by the same amount of space travelled by the wheel 2 due to the pothole along an axis perpendicular to the ground. In this way, the torsional forces exerted on the frame 6 by the wheels 2, 3, 4 and 5 due to the pothole are compensated for by the vertical movement of the wheels 2, 3, 4 and 5, in particular by means of said movement the centre of gravity of the land vehicle 1 is displaced.

Advantageously, but not necessarily, the hydraulic cylinders 12, 13, 14, 15, 16, 17, 18 and 19 belonging to the same compensation system 8, 9, 10 and 11 are coaxial; that is, they have coincident axes of symmetry.

According to some advantageous but not limiting embodiments, the pistons 20 belonging to the same compensation system 8, 9, 10 and 11 are connected to one another so as to substantially move simultaneously.

In this way it is possible to ensure that the pressure transmission inside the hydraulic cylinders 12 and 13, 14 and 15, 16 and 17, 18 and 19 is homogeneous and simultaneous.

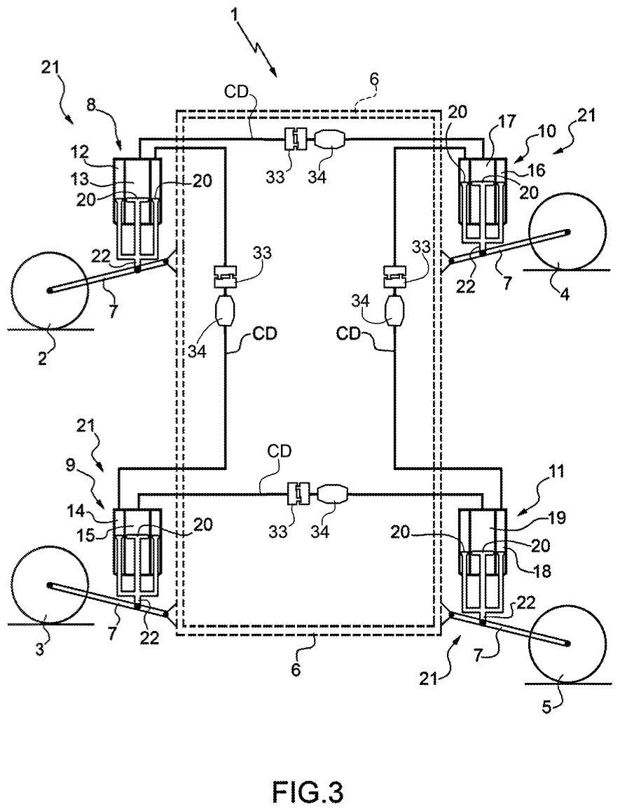

In particular, the pistons 20 belonging to the same compensation system 8, 9, 10 and 11 are integral with one another, more in particular they are mechanically connected by means of a rod 22. More precisely, the rod 22 extends between two pistons 20 belonging to the same compensation system 8, 9, 10 and 11. In some cases (e.g. FIGS. 1 and 3), the rod 22 is a substantially linear element. Alternatively, the rod 22 is branched.

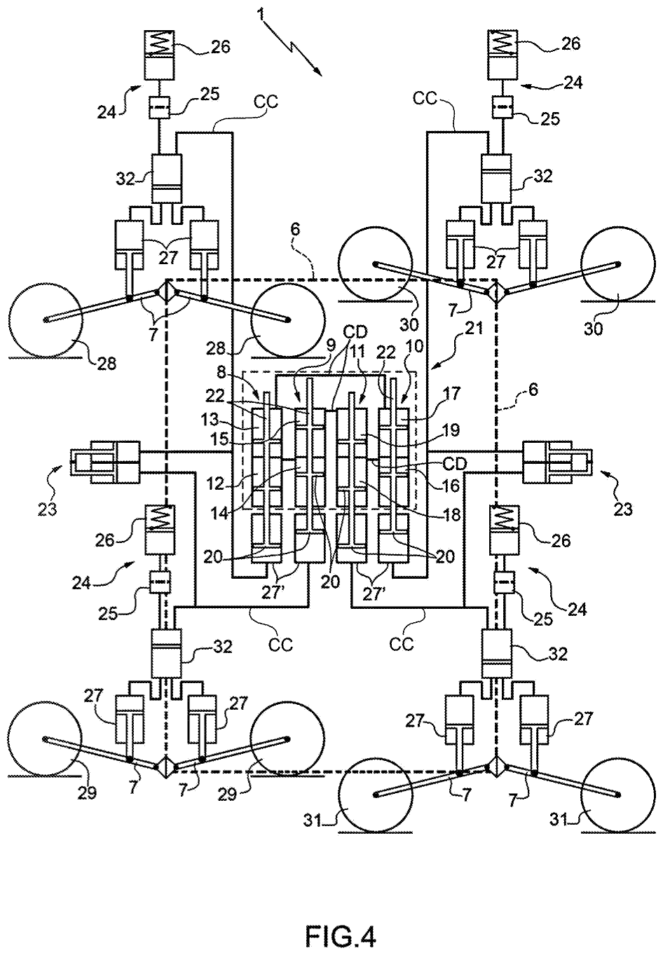

According to some non-limiting embodiments (like for example illustrated in FIGS. 1 and 4), the hydraulic cylinders 12, 13, 14, 15, 16, 17, 18 and 19 belonging to the same compensation system 8, 9, 10 and 11 are arranged in series. In other words, the hydraulic cylinders 12, 13, 14, 15, 16, 17, 18 and 19 belonging to the same compensation system 8, 9, 10 and 11 have a common base. In particular, the hydraulic cylinders 12, 13, 14, 15, 16, 17, 18 and 19 belonging to the same compensation system 8, 9, 10 and 11 have contiguous side surfaces.

According to further non-limiting embodiments, the hydraulic cylinders 12, 13, 14, 15, 16, 17, 18 and 19 belonging to the same compensation system 8, 9, 10 and 11 are arranged in parallel (FIGS. 2, 3 and 5-7).

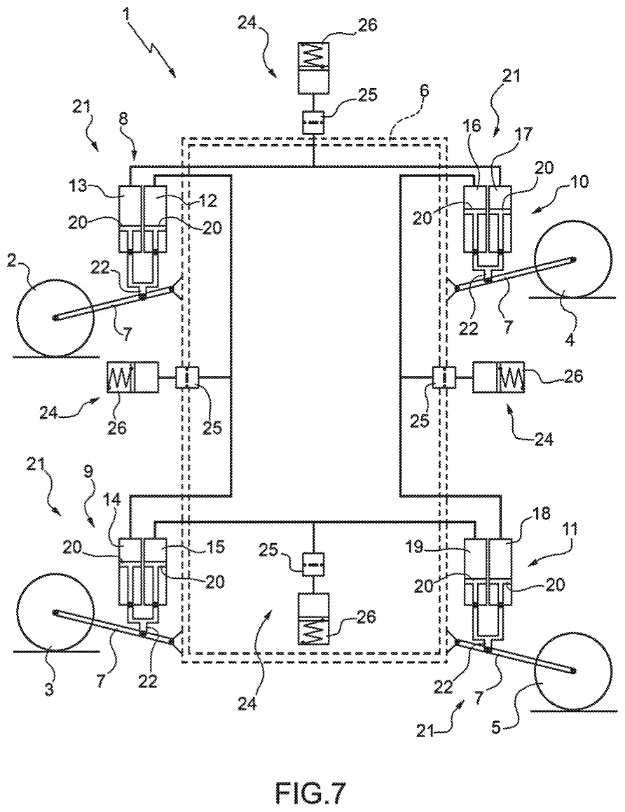

In some cases (FIGS. 6 and 7), the hydraulic cylinders 12, 13, 14, 15, 16, 17, 18 and 19 belonging to the same compensation system 8, 9, 10 and 11 are arranged one next to the other. Alternatively (like for example illustrated in FIGS. 2, 3 and 5), the hydraulic cylinders 12, 13, 14, 15, 16, 17, 18 and 19 belonging to the same compensation system 8, 9, 10 and 11 are concentric.

In some cases (FIGS. 2, 3 and 5), the hydraulic cylinders 12, 14, 16 and 18 are arranged outside the hydraulic cylinders 13, 15, 17 and 19, respectively. More specifically, the hydraulic cylinders 12, 14, 16 and 18 have an annular piston 20 and the hydraulic cylinders 13, 15, 17 and 19, arranged internally with respect to the hydraulic cylinders 12, 14, 16 and 18, have a circular piston 20.

Advantageously but not necessarily, the hydraulic cylinders 12, 13, 14 and 15 of the compensation systems 8 and 9 associated with the front wheels 2 and 3 of the vehicle 1 have pistons 20 with a pushing surface that is different from the one of the hydraulic cylinders 16, 17, 18 and 19 of the compensation systems 10 and 11 associated with the rear wheels 4 and 5 of the vehicle. In this way it is possible to differentiate the reactivity and the stiffness of the compensation systems 8, 9, 10 and 11 between those associated with the front wheels 2 and 3 and those associated with the rear wheels 4 and 5 of the vehicle 1. In particular, the hydraulic cylinders 12, 13, 14 and 15 of the compensation systems 8 and 9 associated with the front wheels 2 and 3 (FIGS. 1 and 2) have pistons 20 with a greater pushing surface than the pistons 20 of the hydraulic cylinders 16, 17, 18 and 19 of the compensation systems 10 and 11 associated with the rear wheels 4 and 5 (FIGS. 1 and 2). In this way, there is a greater roll resistance for the front wheels 2 and 3 (which are generally the steering wheels) with respect to the rear wheels 4 and 5.

In other words, the front wheels 2 and 3, being connected to the pistons 20 with a greater pushing surface than those to which the rear wheels 4 and 5 are connected, tend to discharge more forces to the ground since, in order to move pistons with a greater pushing surface, (at least) equal pressure and therefore a greater force is required. Consequently, the movements of the front wheels 2 and 3, with the same difference in height of the uneven path, are lower than those of the rear wheels 4 and 5. In this way it is also possible to avoid using anti-roll bars, which would otherwise be necessary.

Advantageously but not necessarily, the land vehicle 1 further comprises at least an attitude corrector 23 (FIGS. 1, 2 and 4). In particular, the attitude corrector 23 is designed to vary the height of the frame 6 with respect to the wheels 2, 3, 4 and 5.

In some non-limiting cases (FIGS. 1, 2 and 4), the land vehicle 1 comprises an attitude corrector 23 connected to the front wheels 2 and 3 and an attitude corrector 23 connected to the rear wheels 4 and 5. The attitude correctors 23 are designed to lift or lower the land vehicle 1 at the front and at the back, respectively.

More precisely, the attitude corrector 23 connected to the rear wheels 4 and 5 is designed to vary the height (in particular, to lift and/or lower) of the frame 6 with respect to the rear wheels 4 and 5; the attitude corrector 23 connected to the front wheels 2 and 3 is designed to vary the height (in particular, lift and/or lower) of the frame 6 with respect to the front wheels 2 and 3.

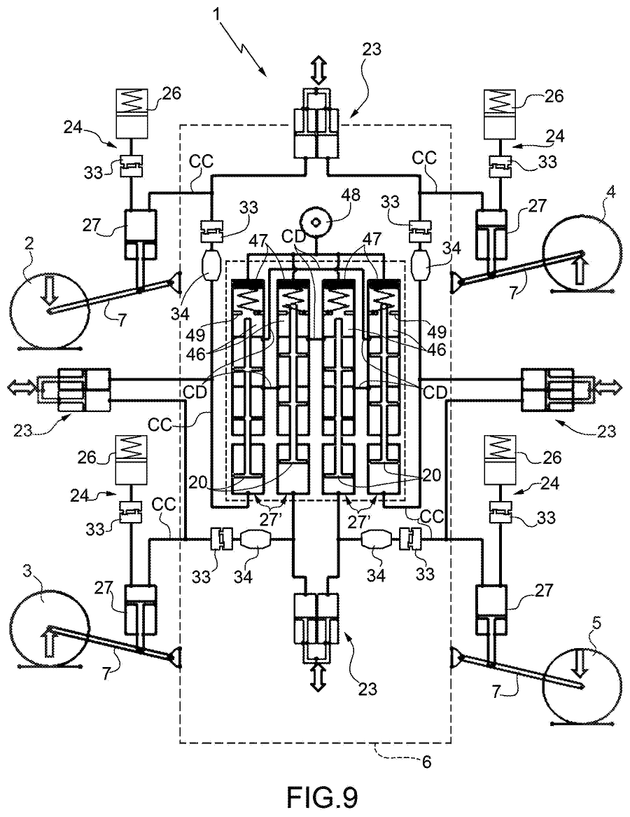

Alternatively or additionally (FIG. 9), the land vehicle 1 also comprises an attitude corrector 23 connected to the right wheels 2 and 4 and an attitude corrector 23 connected to the left wheels 3 and 5. The attitude correctors 23 are designed to lift or lower the land vehicle 1 from the right or left side, respectively. More precisely, the attitude corrector 23 connected to the rear right wheels 2 and 4 is designed to vary the height (in particular, to lift and/or lower) of the frame 6 with respect to the right wheels 2 and 4; the attitude corrector 23 connected to the left wheels 3 and 5 is designed to vary the height (in particular, to lift and/or lower) of the frame 6 with respect to the left wheels 3 and 5.

Advantageously but not necessarily, the attitude correctors 23 have an electric actuator connected to a control unit capable of dynamically adjusting the parameters thereof.

In the event that the land vehicle is a wheelchair for disabled people that has to travel an uphill or downhill stretch of road, the attitude correctors 23 would allow the wheelchair itself not to tilt, while maintaining the safety and comfort of the person who is sitting there unaltered and thus avoiding a possible fall due to the slope of the stretch of road.

Advantageously and as illustrated in the non-limiting embodiments of FIGS. 1, 2 and 4-7, the compensation system 8, 9, 10 and 11 comprises a suspension 24.

Advantageously but not necessarily, the suspension 24 comprises a dashpot 25 and a damping system 26 chosen in the group consisting of: a spring (FIGS. 1, 2 and 4-7), a pneumatic suspension (not shown) or a combination thereof.

In particular, the suspension 24 is not to be considered an accumulation device (unlike the hydraulic accumulators present in the prior art documents), since it allows the accumulation of negligible amounts of fluid (the function thereof is mainly dissipative).

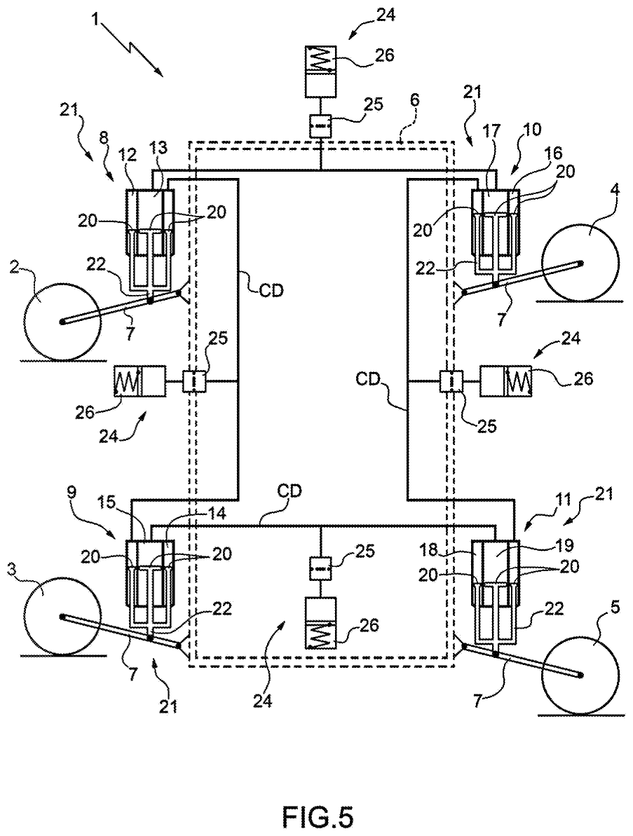

With particular reference to FIGS. 5-7, according to some non-limiting embodiments, the compensation systems 8, 9, 10 and 11 also comprise at least a suspension 24 arranged along one of the connection ducts CD (for example, which connects the front wheels 2 and 3 and/or the rear wheels 4 and 5). In some cases, the compensation systems 8, 9, 10 and 11 comprise a plurality of suspensions 24, each of which is arranged along a respective connection duct CD.

According to some non-limiting embodiments, the compensation systems 8, 9, 10 and 11 (in particular, the hydraulic cylinders 12, 13, 14, 15, 16, 17, 18 and 19) contain a transfer fluid (more precisely, a transfer liquid). In particular, the transfer fluid is at least partially arranged along the connection ducts CD.

The transfer fluid is, in particular, designed to transfer the movement between two different compensation systems 8, 9, 10 and 11 (more precisely, between two movable pistons 20 of two hydraulic cylinders 12, 13, 14, 15, 16, 17, 18 and 19) by moving between the two different compensation systems (more precisely, between the two different cylinders) (directly) connected along the connection duct CD which extends between the same two different compensation systems (more precisely, between the two different cylinders).

More particularly, in use, the volume occupied by the transfer fluid is substantially constant. In other words, when the volume occupied by the transfer fluid inside a first one of the hydraulic cylinders 12, 13, 14, 15, 16, 17, 18 and 19 decreases by a determined amount, the volume occupied by the transfer fluid inside a second one of the cylinders 12, 13, 14, 15, 16, 17, 18 and 19, directly connected to the first cylinder by means of a connection duct CD (the connection duct extends from the first cylinder to the second cylinder) increases by the determined amount.

Advantageously but not necessarily, the transfer fluid comprises (is) a non-compressible fluid, in particular an oily fluid. The term “non-compressible fluid” (typically also called hydraulic fluid) refers to any fluid whatsoever for which the variation in volume as the pressure varies is so small that it can be considered as negligible.

According to advantageous but not limiting embodiments illustrated in FIGS. 1, 2 and 4, the vehicle further comprises transmission cylinders 27 (at least one for each wheel) which are arranged, in a connected manner, between the wheels 2, 3, 4 and 5 and the respective compensation systems 8, 9, 10 and 11 associated therewith. The transmission cylinders 27 are designed to transmit the variation, relative to the frame 6, of the position of one of the wheels 2, 3, 4 and 5 to the compensation system 8, 9, 10 and 11 associated therewith.

In particular, the transmission cylinders 27 are each provided with (at least) a respective actuating piston. In other words, a respective actuating piston is arranged inside each cylinder 27.

More precisely but not necessarily, the vehicle 1 also comprises a plurality of connection ducts CC, each extending from a respective cylinder 27 up to the area of (up to or in proximity to) the compensation system 8, 9, 10 and 11 associated therewith. A transmission fluid (equal or different from the transfer fluid but like it defined) is also provided for, which is at least partially arranged inside the connection ducts CC (and possibly inside the cylinders 27).

In use, the transmission fluid, by moving along the aforesaid connection ducts CC, transfers the movement from the cylinder 27 to the compensation system 8, 9, 10 and 11 associated therewith.

Advantageously but not necessarily, the land vehicle 1 comprises two transmission cylinders 27 arranged between each wheel 2, 3, 4 and 5 and the respective compensation system 8, 9, 10 and 11. In particular, the land vehicle 1 has, for each wheel 2, 3, 4 and 5, a first transmission cylinder 27 arranged in proximity to the wheel 2, 3, 4 and 5 itself, and a second transmission cylinder 27′, which is fluidically connected to the cylinder 27 and connects (is interposed between) the cylinder 27 to the respective compensation system 8, 9, 10 and 11 so as to transmit a movement between the cylinder 27 and the respective system 8, 9, 10 and 11.

In particular, the cylinder 27′ is arranged in proximity to the compensation system 8, 9, 10 and 11 associated with the wheel 2, 3, 4 and 5.

More precisely but not necessarily, in these cases, each connection duct CC extends from a respective cylinder 27 to a respective cylinder 27′.

In use, the transmission fluid, by moving between the cylinders 27 and 27′ (along the connection duct CC) transfers the movement between the cylinder 27 and the respective cylinder 27′ (and hence the compensation system 8, 9, 10 and 11 associated therewith).

Advantageously but not necessarily, the vehicle 1 has a piston 20 arranged inside the (of each) cylinder 27′. The actuating piston is designed to transfer movement to the respective piston 20 arranged inside the cylinder 27′ by moving the transmission fluid (along the connection duct CC). In particular, the (each) actuating piston is (directly) connected to a respective joint 7 so that a movement of the joint 7 corresponds to a movement of the actuating piston.

According to some non-limiting embodiments (FIGS. 1 and 4), the rod 22 extends from the piston 20 arranged inside the cylinder 27′ through a piston 20 arranged inside a cylinder 12, 14, 16 and 18 (of the respective compensation system 8, 9, 10 and 11) to a piston 20 arranged inside a cylinder 13, 15, 17 and 19 (of the respective compensation system 8, 9, 10 and 11).

Advantageously but not necessarily, each wheel 2, 3, 4 and 5 is mechanically connected to the transmission cylinder 27 by means of the connection joints 7.

According to some embodiments (FIGS. 1, 2 and 4) each suspension 24, associated with the respective compensation system 8, 9, 10 and 11, is mounted (directly connected) to the transmission cylinder 27. In this way, in the event of impulsive shocks due to a rough terrain, the suspension 24 is able to compensate for the impulse suffered by the wheel 2, 3, 4 and 5, before the same is transmitted to the frame 6 or to the other wheels 2, 3, 4 and 5. In particular, by adjusting the preload of the damping system 26, it is possible to set the threshold value for the intensity of the impulse above which the suspension 24 activates and dampens said impulse at least in part. According to said embodiments, the transmission cylinder 27′, located in proximity to the control unit 21, is directly (fluidically) connected to the transmission cylinder 27.

Advantageously but not necessarily, the transmission cylinder 27′ (located in proximity to the control unit 21) is coaxial with the hydraulic cylinders 12, 13, 14, 15, 16, 17, 18 and 19 of the respective compensation system 8, 9, 10 and 11. In particular, the transmission cylinder 27′ (located in proximity to the control unit 21) has a rod which is integral with the (at least one of) the pistons 20 of the respective compensation system 8, 9, 10 and 11; more in particular, the transmission cylinder 27′ has a rod which is integral with the (is part of) the rod 22 that is common to the hydraulic cylinders belonging to the same compensation system 8, 9, 10 and 11.

According to some non-limiting embodiments, the cylinder 27′ is absent and the (each) cylinder 27 is directly connected to the respective cylinder 12, 14, 16 and 18 (on the opposite side of the relative piston 20 with respect to the zone designed to be occupied by the transfer fluid). In other words, the respective connection ducts CC extend from (from each) cylinder 27 to the respective cylinder 12, 14, 16 and 18 (on the opposite side of the relative piston 20 with respect to the zone designed to be occupied by the transfer fluid). In these cases, in use, the transmission fluid moves from the cylinder 27 to the corresponding cylinder 12, 14 16 and 18 and acts directly on the piston 20 of the corresponding cylinder 12, 14, 16 and 18.

By way of example, in use: in the non-limiting embodiments illustrated in FIGS. 1 and 2, therefore, if the wheel 2 is subjected to a lowering action due, for example, to a pothole in the ground, it causes a lowering, through the respective connection joint 7, of an actuating piston inside the transmission cylinder 27. The actuating piston propagates the movement (by lowering) to the transmission cylinder 27′ (whose movable piston 20 in turn is lowered) located in proximity to the control unit 21 and with the rod 22 in common with the cylinders 12 and 13 of the compensation system 8. The piston 20 of the cylinder 12, which is directly connected to the cylinder 14 of the compensation system 9 associated with the wheel 3, in turn propagates (by lowering) the movement of the wheel 2 to the compensation system 9 (and therefore to the wheel 3), hence causing the pistons 20 of the cylinders 14 and 15 of the compensation system 9 to lift, which cylinders 14 and 15, being connected through the respective transmission cylinders 27 and 27′ to the wheel 3, cause the lifting (of the wheel 3) thereof. Similarly, the piston 20 of the cylinder 13, which is directly connected to the cylinder 17 of the compensation system 10 associated with the wheel 4, in turn propagates (by lowering) the movement of the wheel 2 to the compensation system 10 (and therefore to the wheel 4) causing the pistons 20 of the cylinders 16 and 17 of the compensation system 10 to lift, which cylinders 16 and 17, being connected through the respective transmission cylinders 27 and 27′ to the wheel 4, cause the lifting (of the wheel 4) thereof. In the same way, the upward movement of the wheels 3 and 4 is transmitted by the cylinders 15 and 16, respectively, to the cylinders 19 and 18 (whose pistons 20 consequently are lowered) of the compensation system 11 (and therefore to the wheel 5); said movement therefore causes a consequent lowering of the wheel 5. In summary, thanks to the exchange of transfer fluid between the hydraulic cylinders 12, 13, 14, 15, 16, 17, 18 and 19 of the compensation systems 8, 9, 10 and 11, the lifting of the two wheels arranged on the same side of the vehicle (right or left, front or rear) and the lowering of the opposite wheel correspond to a lowering of a wheel. In other words, as shown in FIGS. 1 and 2, the lifting of the two wheels 3 and 4 arranged on the same side of the vehicle (right or left, front or rear) and the lowering of the wheel 5 opposite to the wheel 2 correspond to a lowering of the wheel 2.

Thanks to the use of the transmission cylinders 27 and 27′ it is possible to join all the compensation systems 8, 9, 10 and 11 in a reduced volume, rather than arranging them individually in proximity to the wheels 2, 3, 4 and 5 as illustrated in FIGS. 3 and 5-7.

FIGS. 3 and 5-7 illustrate, in fact, non-limiting embodiments of the present invention, in which the transmission cylinders 27 and 27′ are not present and consequently the control unit 21 is not joined in a central position and the single compensation systems 8, 9, 10 and 11 are arranged in a direct connection with the wheels 2, 3, 4 and 5 associated therewith. In particular, according to said embodiments, the control unit 21 is distributed in proximity to the wheels 2, 3, 4 and 5. More precisely, the single compensation systems 8, 9, 10 and 11, which are part of the control unit 21, are each arranged at a respective wheel 2, 3, 4 and 5.

FIG. 4 illustrates an embodiment of a land vehicle according to the present invention and provided with eight wheels, associated one with another in four pairs: the front right wheels 28, the front left wheels 29, the rear right wheels 30 and the rear left wheels 31. Each pair of wheels 28, 29, 30 and 31 is connected to the compensation systems 8, 9, 10 and 11 through a local compensation cylinder 32 which, if possible, i.e. in the event that a wheel of one of the pairs of wheels 28, 29, 30 and 31 is higher than the other one of the same pair, makes it possible (by allowing the flow of fluid between the two respective cylinders 27) to compensate (if and where possible) for the difference in height between the two wheels of the same pair of wheels 28, 29, 30 and 31. In particular, in the event that one of the wheels of a pair is subjected to a lifting or lowering action due to a roughness of the terrain, the local compensation cylinder 32 allows the flow of fluid between the two respective cylinders 27, making the other wheel of the same pair of wheels 28, 29, 30 and 31 lift or lower.

More precisely, the movement of the actuating pistons (due to the lifting and/or lowering of the wheels connected thereto) arranged inside the (two) cylinders 27 causes a displacement of fluid between the cylinders 27 (on the one hand) and the cylinder 32 (on the other hand).

Said displacements of fluid (if not completely compensated between the two cylinders 27) leads to the movement of the piston arranged inside the cylinder 32 by a distance proportional to the algebraic sum of the volume of the fluid displaced between the cylinders 27 and the cylinder 32.

In other words, the amount (the volume) of transmission fluid that moves between the cylinder 32 and the control unit 21 (or the cylinder 27′) is a sort of average of the amounts (volumes) of fluids that move between the cylinders 27 (on the one hand) and the cylinder 32 (on the other hand).

In particular, as illustrated in FIG. 4, in the event that the two right front wheels 28 are subjected to a lowering action due, for example, to a pothole on a ground, the left front wheels 29 and the rear right wheels 30 are subjected to a lifting action, while the left rear wheels 31 are lowered, so as to eliminate the torsions that would be created on the frame 6. More in particular, the wheels 29 and 30 would lift and the wheels 31 would lower by the same amount of space travelled by the wheels 28 due to the pothole along an axis perpendicular to the ground.

Advantageously but not necessarily, said system the land vehicle 1 according to the present invention reduces the degrees of freedom of the wheels 2, 3, 4 and 5 from four to one, since, through the respective compensation systems 8, 9, 10 or 11, the movements of the wheels 2, 3, 4 and 5 are no longer independent of one another, but the movement of one wheel corresponds to the movements of the others.

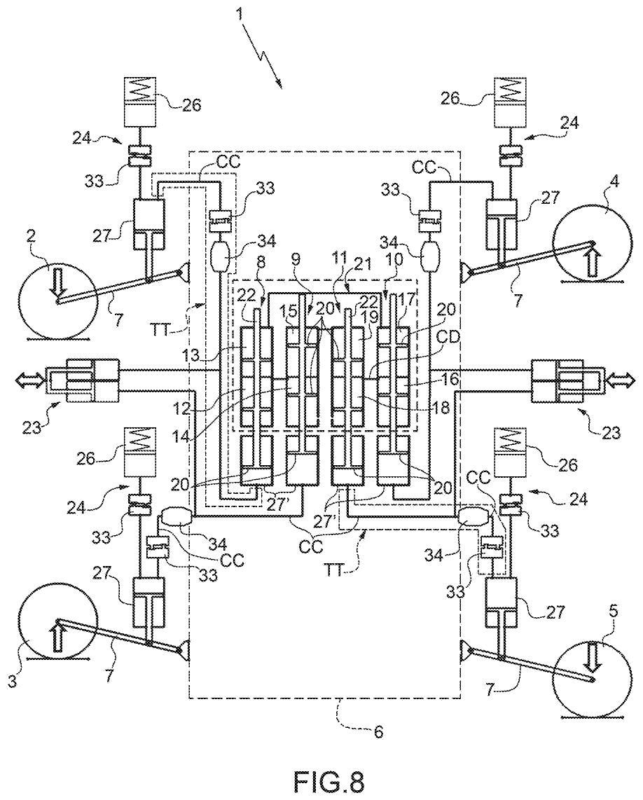

Advantageously but not necessarily, and as illustrated in the non-limiting embodiments of FIGS. 8 and 9, the vehicle 1 comprises a plurality of dampers 33, which are each arranged between the wheel 2, 3, 4 or 5 and the respective compensation system 8, 9, 10 or 11. In particular, the dampers 33 are viscous dampers designed to dampen any impulsive movements (impulses) of the transmission fluid (and/or of the transfer fluid), determined by the variation in position of the wheels 2, 3, 4 and 5 relative the frame 6, and avoiding transmitting them directly to the hydraulic control unit 21.

In particular, in this way, in use, the viscous dampers 33 dampen the impulses coming from the wheels 2, 3, 4 and 5 proportionally to the impulse module of the transmission fluid. In other words, if the wheel 2, 3, 4 or 5 encounters a sudden roughness of the terrain, it generates an impulse (sudden impulsive movement) of the transmission fluid from or to the hydraulic control unit 21, which is damped proportionally by the viscous damper 33. Therefore, in the case, for example of a slight bump, the impulse (having a low modulus) of the transmission fluid towards the control unit will be slightly dampened by the dampers 33; while in the case, for example, of a high and/or sudden bump, the impulse (having a high modulus) of the transmission fluid towards the control unit will be strongly dampened by the dampers 33.

Advantageously, by using the viscous dampers 33, the control unit 21 undergoes less stress and breaks and malfunctions thereof due to excessive dynamics of the transmission fluid (and/or of the transfer fluid) are avoided.

Advantageously but not necessarily, the viscous dampers 33, by damping the speed of the transmission fluid towards the control unit, determine a concentration of said impulse on the suspension 24, which will dissipate it.

In particular, the viscous dampers 33 are not compensation systems or hydraulic cylinders or actuators, but are passive elements.

According to the non-limiting embodiment illustrated in FIG. 8, the viscous damper 33 is arranged between one of the transmission cylinder 27 and the respective transmission cylinder 27′. In particular, the viscous damper 33 is arranged on a section TT of the (hydraulic) connection duct CC directly connected to the respective cylinder 27′. The term “directly connected” means that the section TT does not have further hydraulic cylinders or other actuators (and/or non-dead end branches) between the cylinder 27′ and the respective viscous damper 33.

In particular, the attitude correctors 23 are not to be considered as actuator devices, since they do not influence the transmission of the movement of the wheels and/or the movement of the transmission fluid.

According to other non-limiting and not illustrated embodiments, the viscous damper 33 is arranged in any section of the connection between the wheel 2, 3, 4 or 5 and the respective compensation system 8, 9, 10 or 11.

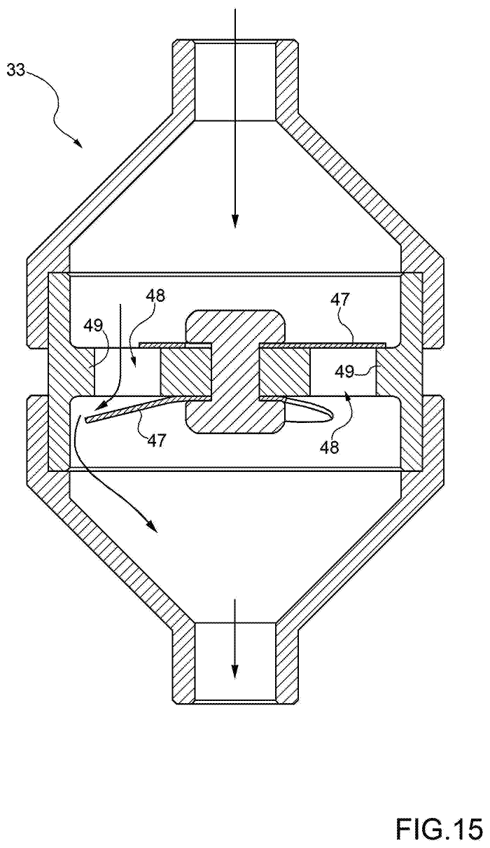

In some non-limiting cases, like the one illustrated in the non-limiting embodiment of FIG. 15, the damper 33 allows the transmission fluid to flow in its inside (note the arrows indicating the flow of the transmission fluid). In particular, in such cases the dampers 33 are viscous dampers 33 comprising blades 50, that is containing one or more ducts 51 inside which the transmission fluid flows. Said ducts 51 are obstructed by elastic blades 50 which react (they bend, as illustrated in FIG. 15) proportionally to the speed of the transmission fluid which they allow to flow through the viscous damper 33.

Advantageously but not necessarily, and as illustrated in the non-limiting embodiment of FIG. 15, the damper 33 comprises a pair of blades 50. In particular, the viscous damper 33 comprises (at least) two blades 50, of which (at least) one allows the transmission fluid to flow in one direction and (at least) the other one allows the transmission fluid to flow in the other direction. While a blade 50 bends under the thrust of the transmission fluid allowing the flow through the respective duct 51, the other blade 50 in turn blocks the corresponding duct 51 by abutting on a limit switch 52.

Advantageously but not necessarily, by adjusting the stiffness of the blades 50, it is possible to adjust the dissipation factor of the viscous damper 33.

In other non-limiting and not illustrated cases, the viscous damper 33 is of the linear type and comprises a (cylindrical) body inside which a piston is immersed into a (Newtonian) fluid and moves linearly inside it.

In further non-limiting and not illustrated cases, the viscous damper 33 is of the circular type and comprises a (cylindrical) body inside which a piston is immersed into a (Newtonian) fluid and rotates inside it.

In the latter two cases, the transmission fluid does not flow through the viscous damper 33, but is stopped by the respective piston, which transmits the damped motion to a further transmission fluid arranged downstream of the viscous damper 33 which may be the same or different from the one arranged upstream of the viscous damper 33.

Advantageously but not necessarily, and as illustrated in the non-limiting embodiments of FIGS. 8 and 9, the vehicle 1 comprises a plurality of hydraulic filters 34, which are each arranged between the wheel 2, 3, 4 or 5 and the respective compensation system 8, 9, 10 or 11.

In particular, the hydraulic filters 34 are low-pass filters designed to reduce (in particular stop), in case of undesired frequencies, the flow of the transmission fluid inside the connection ducts CC (hence, the flow of the transfer fluid inside of the connection ducts CD) and hence, the association between the wheel 2, 3, 4 or 5 and the respective compensation system 8, 9, 10 or 11.

More precisely, hydraulic filters are bandpass filters.

In particular, the hydraulic filters 34 are not compensation systems or hydraulic cylinders or in any case actuators, but are passive elements.

Advantageously but not necessarily, the hydraulic filters 34 are designed to eliminate undesired frequencies by stopping the flow of the transmission fluid inside the connection ducts DC (hence, the flow of the transfer fluid inside the connection ducts CD).

In other words, the hydraulic filters 34 are designed to avoid the spread of resonance frequencies, which, if transmitted from one to the other wheels, would generate an uncontrolled increase of the energy inside the compensation systems 8, 9, 10 or 11 that could lead to the component breakage and/or a danger to the user.

Advantageously but not necessarily, and as illustrated in the non-limiting embodiments of FIGS. 8 and 9, the filters 34 are arranged in series with the respective viscous dampers 33. In particular, the hydraulic filters 34 are arranged between a viscous damper 33 and the respective compensation system 8, 9, 10 or 11. More particularly, the hydraulic filters 34 are arranged between a viscous damper and the respective further transmission cylinder 27′.

In some non-limiting cases like the ones illustrated in FIGS. 8 and 9, the land vehicle 1 comprises both the viscous dampers 33 (in particular at least 1 for each wheel 2, 3, 4 or 5), and the hydraulic filters 34 (in particular at least 1 for each wheel 2, 3, 4 or 5).

In other non-limiting and not illustrated cases, the land vehicle 1 comprises the viscous dampers 33 (in particular at least 1 for each wheel 2, 3, 4 or 5), but not the hydraulic filters 34 (in particular at least 1 for each wheel 2, 3, 4 or 5).

In further non-limiting and not illustrated cases, the land vehicle 1 comprises the hydraulic filters 34 (in particular at least 1 for each wheel 2, 3, 4 or 5), but not the viscous dampers 33 (in particular at least 1 for each wheel 2, 3, 4 or 5).

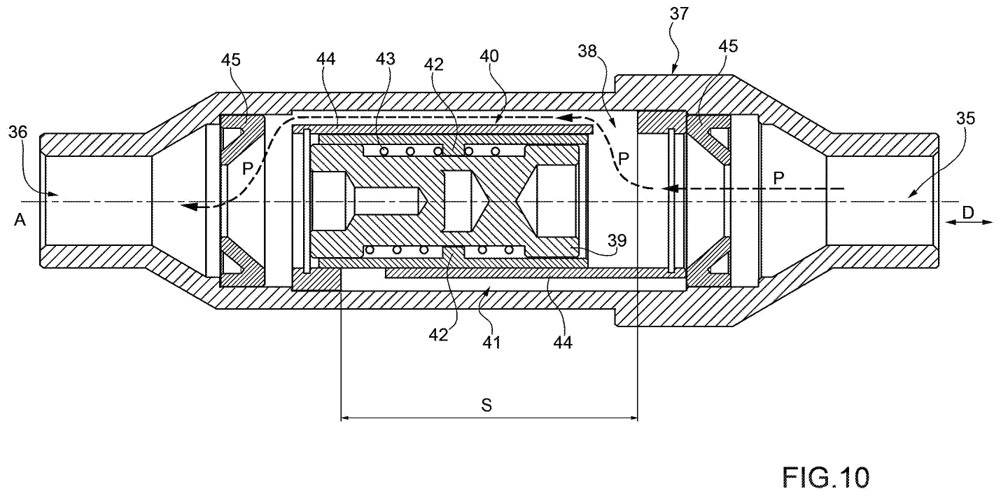

FIGS. 10, 11 and 12 illustrate a non-limiting embodiment of the hydraulic filter 34 in different configurations.

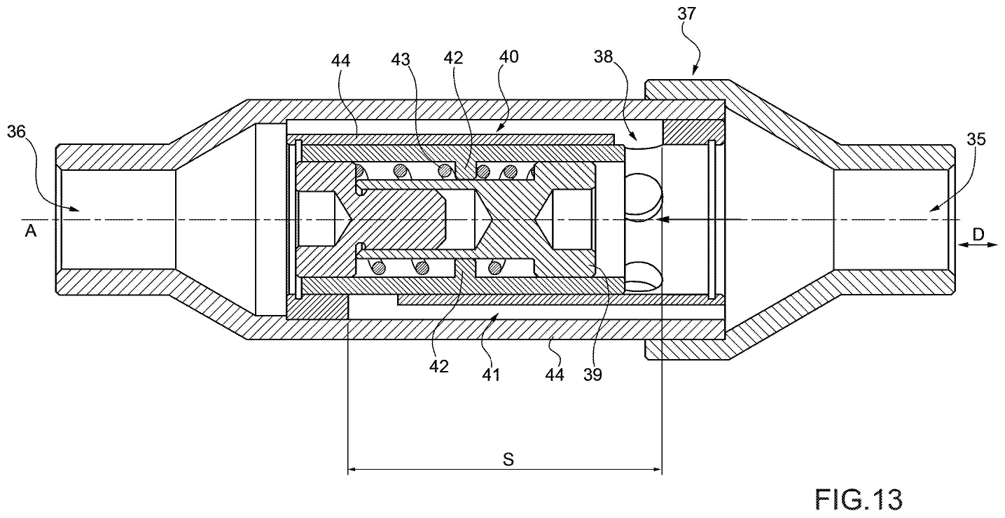

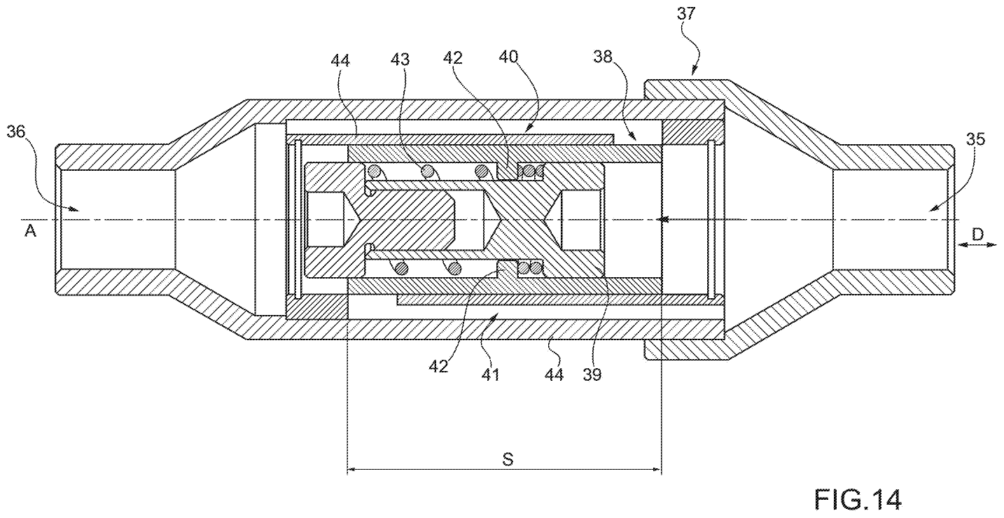

FIG. 13 illustrates a further embodiment of the hydraulic filter 34 in a disengagement configuration, while FIG. 14 shows the same embodiment in a blocking configuration.

FIG. 10 illustrates a hydraulic filter 34 which allows the transmission fluid (i.e. the fluid or the fluids that connect the wheels 2, 3, 4 and 5 to the hydraulic control unit 21) to flow from the duct 35 to the duct 36.

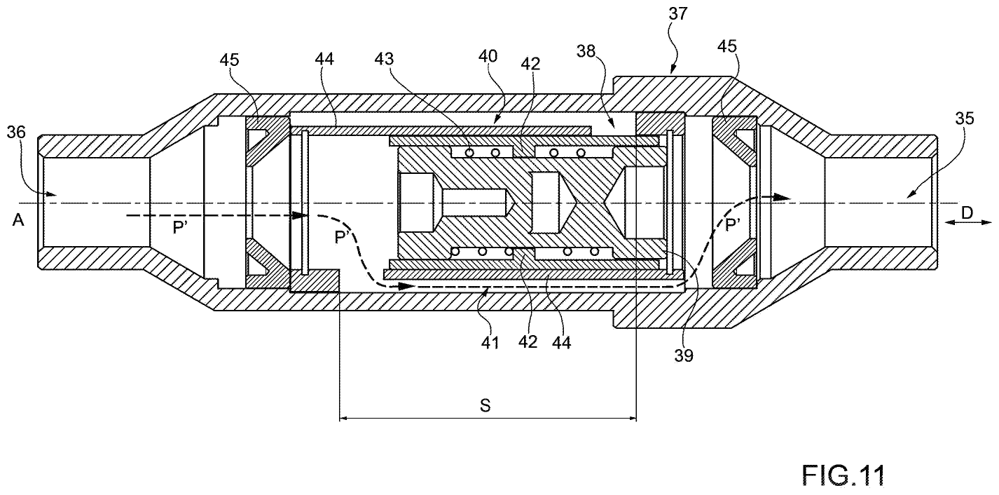

FIG. 11 illustrates a hydraulic filter 34 which allows the transmission fluid (i.e. the fluid or the fluids that connect the wheels 2, 3, 4 and 5 to the hydraulic control unit 21) to flow from the duct 36 to the duct 35.

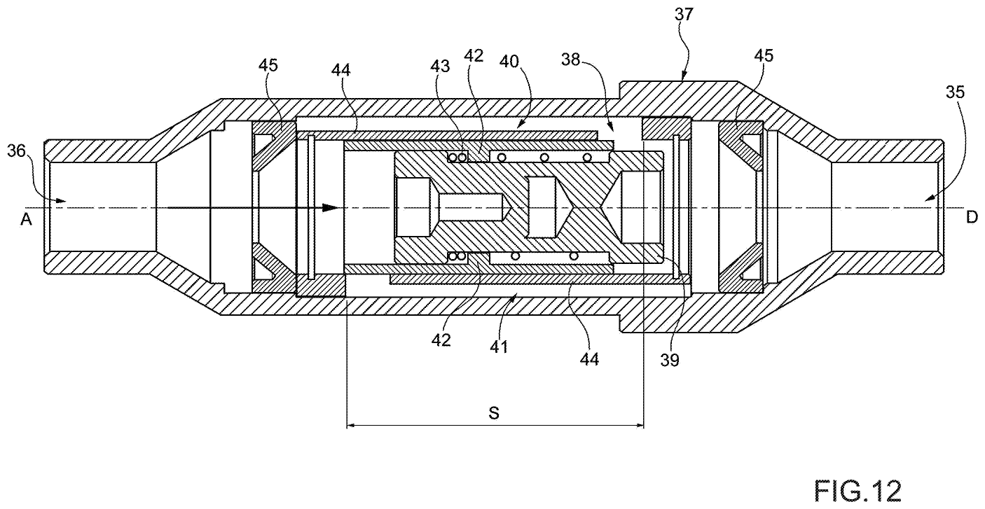

FIG. 12 shows a hydraulic filter 34 which blocks the flow of the transmission fluid (i.e. the fluid or fluids that connect the wheels 2, 3, 4 and 5 to the hydraulic control unit 21) between the ducts 35 and 36.

Each hydraulic filter 34 (FIGS. 10-13) comprises a main body 37, which mechanically connects the duct 35 to the duct 36 and vice versa. In particular, the main body 37 delimits a filtering chamber 38, inside which the filtering of the frequencies takes place.

The filter 34 further comprises a movable mass 39 (i.e. a piston), which is movable along a conveying direction D. The mass 39 is arranged inside the filtering chamber 38 and can assume different positions (as illustrated in FIGS. 10, 11 and 12) along the conveying direction D based on the direction (and the frequency with which said direction changes) of the transmission fluid.

In the non-limiting embodiment of FIGS. 10, 11, 12 and 13, each hydraulic filter 34 comprises, in particular inside the filtering chamber 38, a passage channel 40 which allows the movement of the transmission fluid from the duct 35 to the duct 36, and a passage channel 41 which allows the movement of the transmission fluid from the duct 36 to the duct 35.

According to other non-limiting embodiments, the filter 34 comprises a number of passage channels other than two (one, three, four, etc.).

In particular, in addition, each hydraulic filter 34 comprises a shutter 42, which is arranged inside the filtering chamber 38, mounted movable with respect to the mass 39, and capable of assuming different positions along the conveying direction D.

In some non-limiting cases (as illustrated in FIG. 10), the shutter 42 is in a first disengagement position, which allows the transmission fluid to flow along a path P from the duct 35 to the duct 36 through the passage channel 40 (as indicated by the appropriate arrows).

In other non-limiting cases (like the one illustrated in FIG. 11), the shutter 42 is in a second disengagement position, which allows the transmission fluid to flow along a path P′ from the duct 36 to the duct 35 through the passage channel 41 (as indicated by the appropriate arrows).

In further non-limiting cases (like the one illustrated in FIGS. 12 and 13), the shutter 42 is in a blocking position, which simultaneously prevents the fluid from flowing through by blocking the passage channels 40 and 41.

Advantageously and in order to dampen (eliminate) certain resonant frequencies at which the transmission fluid can move, inside the ducts 40 and 41, each hydraulic filter 34 comprises an elastic element 43 which mechanically connects the shutter 42 and the mass 39, so that the shutter 42 follows the movements of the mass 39 with a delay.

According to some non-limiting embodiments (like the ones illustrated in FIGS. 10, 11, 12 and 13), the elastic element 43 is a spring.

Advantageously but not necessarily, the stiffness (therefore also the elasticity which is equivalent to the inverse of the stiffness) of the elastic element 43 determines the frequency of the resonant movements of the transmission fluid at which the shutter 42 stops in the (in proximity to) position (or in the) the blocking position(s) (FIGS. 12 and 13).

According to some non-limiting embodiments (like the ones illustrated in FIGS. 10, 11, 12 and 13), the shutter 42 is arranged between the movable mass 39 and an inner side wall 44 of the passage channels 40, 41.

Advantageously but not necessarily and as illustrated in FIGS. 10, 11, 12 and 13, the shutter 42, the movable mass 39 and the inner side wall 44 of the passage channels 40, 41 are (at least partially) coaxial. In this way, sliding one against the other along the same axis A, in particular corresponding to the longitudinal axis of the hydraulic filter 34, cause (easily and requiring little maintenance) the closing and/or opening of the passage channels 40 and 41.

According to some non-limiting embodiments (like the ones illustrated in FIGS. 10, 11 and 12), the shutter 42 has a length lower than the segment S, that is, the length necessary to be able to simultaneously block all the passage channels 40 and 41. Therefore, advantageously but not necessarily, the hydraulic fluid 34 comprises fluid direction selection devices 45. In particular, said devices 45 are rings, arranged at the ends of the filtering chamber 38, more precisely, in the area of the duct 40 and the duct 41, respectively.

According to some non-limiting embodiments (like the one illustrated in FIGS. 13 and 14), the shutter 42 has a length greater than or equal to the segment S, that is, the length necessary to be able to simultaneously block all the passage channels 40 and 41. Therefore, in use, when the transmission fluid oscillates with an undesired frequency, the delay of the shutter 42 with respect to the mass 39 is such that the shutter 42 remains stationary while the mass 39 moves relative to it and on the basis of the movement of the transmission fluid. In this case, the presence of the direction selection devices 45 is not necessary.

In particular, in use, the oscillatory movement (lifting and lowering) of the wheels 2, 3, 4 and 5 caused by the roughness of the terrain (potholes, stones, bumps, etc.) causes a corresponding oscillatory movement of the transmission fluid inside of the connection ducts CC (on the connection section TT) between each wheel 2, 3, 4 and 5 and the respective compensation system 8, 9, 10 and 11. This oscillatory movement therefore comprises two phases (the sequence of which depends on the roughness of the terrain): a first phase, during which the transmission fluid moves from the wheels 2, 3, 4 and 5 to the control unit 21 (i.e. to the compensation systems 8, 9, 10 and 11), in particular from the duct 35 to the duct 36 (as illustrated in FIG. 10); and a second phase, during which the transmission fluid moves from the control unit 21 (i.e. from the compensation systems 8, 9, 10 and 11) to the wheels 2, 3, 4 and 5, in particular from the duct 36 to the duct 35 (as illustrated in FIG. 11).

During the first phase and as illustrated in FIG. 10 or FIG. 13, the transmission fluid pushes the movable mass 39 (and possibly also the direction selection devices 45) in the direction of the duct 36. The movable mass 39 therefore drags the shutter 42 with a certain delay (caused by the stiffness of the elastic element 43), so as to free the passage channel 40.

During the second phase and as illustrated in FIG. 11, the transmission fluid moves in the direction that is opposite to that of the first phase and pushes the movable mass 39 (and possibly also the direction selection devices 45) in the direction of the duct 35. The movable mass 39 therefore drags the shutter 42 with a certain delay (caused by the stiffness of the elastic element 43), so as to free the passage channel 41.

As schematically illustrated in the embodiments of FIGS. 12 and 14, as the frequency of the oscillatory movements of the transmission fluid increases (and the alternation of the first and second phase), the delay of the position of the shutter 42 with respect to the position of the mass 39 also increases.

By appropriately adjusting the stiffness of the elastic element 43 (the spring), if the frequency of the oscillatory movements is closer to the resonance frequency (or the natural frequency) of the vehicle 1 or part thereof (that is the sub-parts thereof), the delay between the mass 39 and the shutter 42 is such that (as illustrated in FIG. 12) during the first phase (when the transmission fluid tries to flow through the passage channel 40) the shutter blocks the passage channel 40 (and possibly the direction selection devices 45 block the channel 41), and during the second phase (when the transmission fluid tries to flow through the passage channel 41), the shutter blocks the passage channel 41 (and possibly the direction selection devices 45 block the channel 40). In other words, when the frequency of the oscillatory movements is closer to a frequency of possible resonance, the shutter 42 and the mass 39 are substantially in phase opposition (or in any case with a high phase shift) and therefore the hydraulic filter 34 reduces more and more (even up to stopping) the flow of the transmission fluid between the duct 35 and the duct 36.

According to some non-limiting embodiments, like the one illustrated in FIG. 3, a viscous damper 33 and/or a hydraulic filter 34 are arranged along (at least) a connection duct CD between a compensation system 8, 9, 10 or 11 and another one.

Advantageously but not necessarily, and as illustrated in the non-limiting embodiment of FIG. 9, the hydraulic control unit 21 comprises levelling cylinders 46. In particular, each compensation system 8, 9, 10 and 11 comprises a respective levelling cylinder 46. More particularly, inside each levelling cylinder 46 there is (at least) a respective levelling piston 47.

In some non-limiting cases like the one illustrated in FIG. 9, the levelling cylinders 46 are arranged in series (and are coaxial) with the hydraulic cylinders of the respective compensation system 8, 9, 10 or 11.

In other non-limiting and not illustrated cases, the levelling cylinders 46 are arranged in parallel (and are coaxial) with the hydraulic cylinders of the respective compensation system 8, 9, 10 or 11.

Advantageously but not necessarily, the levelling pistons 47 are monostable pistons, that is, with a single predefined rest position (ensured by a spring).

Advantageously but not necessarily, and as illustrated in the non-limiting embodiment of FIG. 9, the levelling cylinders 46 are connected to a hydraulic pump 48. Therefore, said hydraulic pump causes the levelling pistons 47 to be lowered or lifted by injecting a levelling fluid into the levelling cylinders 46.

Advantageously but not necessarily, at least one limit switch element 49 is inserted inside each compensation cylinder 46, which limit switch is arranged in such a way that if the levelling piston 47 is in contact with the limit switch element 49, the rod 22 of the compensation system 8, 9, 10 or 11 remains blocked (thus blocking the operation of the hydraulic control unit 21).

In use, if a malfunction of the hydraulic control unit 21 were to be detected (or a possible risk in the transmission of energy between one wheel and the other, as in the case, for example, of a puncture), the pump 48 fills the levelling cylinders 46 until the pistons 47 touch the respective limit switch element 49 so as to block the rods 22 and therefore the whole hydraulic control unit 21.

Advantageously but not necessarily, once the pump 48 has filled the levelling cylinders 46 and the pistons 47 are in contact with the respective limit switch 49, the hydraulic control unit 21 is blocked so that all the wheels 2, 3, 4, 5 are at the same height from the ground. In case, for example, of a puncture (or of a loss of pressure of a tire), since the wheels 2, 3, 4, 5 are at the same height, the punctured wheel 2, 3, 4 or 5 does not support the weight of the vehicle (which will be distributed on the other wheels 2, 3, 4, 5) and can be replaced or repaired in a short time, in particular facilitating the use of the lifting jack (it is necessary to lift the vehicle by means of the lifting jack).

In other words, through the pump 48 it is possible to disable (block) the hydraulic control unit 21.

Advantageously but not necessarily, the hydraulic pump 48 can be operated at the discretion of a user who wishes to enable or disable the hydraulic control unit 21 and therefore the adaptation of the wheels to the ground.

According to some non-limiting embodiments (like the one illustrated in FIG. 9), the levelling cylinders 46 are connected to a single hydraulic pump 48.

In some non-limiting and not illustrated embodiments, the levelling cylinders 46 associated with wheels 2, 3, 4, 5 belonging to the same side of the vehicle 1 are associated with a respective pump 48 which controls the filling of a pair of levelling cylinders 46.

In other non-limiting and non-illustrated embodiments, each levelling cylinder 46 is associated with a respective pump 48 which controls the filling thereof.

According to some embodiments not illustrated, the vehicle 1 is provided with six wheels. In particular, the vehicle 1 is provided with two front wheels and two pairs of rear wheels (therefore 4 rear wheels, like in the embodiment illustrated in FIG. 4).

According to some further embodiments not illustrated, the vehicle 1 is provided with six wheels. In particular, the vehicle 1 is provided with two rear wheels and two pairs of front wheels (therefore 4 front wheels, like in the embodiment illustrated in FIG. 4).

Advantageously but not necessarily, the movable mass comprises a calibrated hole designed to allow a minimum part of the transmission fluid to flow when the shutter is in at least one of the blocking positions, in this way, the filter also acts as a damper.

In particular, when the filter stops (or greatly reduces) the flow of the transmission fluid, the resonance frequency of the fluid changes from the natural frequency of the wheel—tire system to the natural frequency of the frame—tire system (which is a function of the preload of an accumulator that dissipates it).

Advantageously but not necessarily, all the positions of the illustrated hydraulic filters can, according to the needs, be implemented in all the described embodiments (even if not explicitly illustrated in the drawings).

According to a further non-limiting aspect 1 of the present invention, a land vehicle 1 is provided comprising: a frame 6; at least four wheels 2, 3, 4, 5; and at least four compensation systems 8, 9, 10, 11 each associated with a respective wheel 2, 3, 4, 5; wherein each compensation system 8, 9, 10, 11 comprises at least two hydraulic cylinders 12, 13, 14, 15, 16, 17, 18, 19, and at least two pistons 20, each arranged inside a relative cylinder 12, 13, 14, 15, 16, 17, 18, 19; each cylinder 12, 13, 14, 15, 16, 17, 18, 19 and the relative piston 20 arranged inside the cylinder 12, 13, 14, 15, 16, 17, 18, 19 are mounted so that they can move relative to one another; at least one of each cylinder 12, 13, 14, 15, 16, 17, 18, 19 and the relative piston 20 is connected to the wheel 2, 3, 4, 5 associated with the respective compensation system 8, 9, 10, 11 so as to move depending on the variation of the position of said wheel 2, 3, 4, 5 relative the frame 6; the vehicle 1 further comprises a control unit 21, in particular a hydraulic control unit, which comprises the compensation systems 8, 9, 10, 11 and connects each wheel 2, 3, 4, 5 to the other wheels 2, 3, 4, 5 by means of the hydraulic cylinders 12, 13, 14, 15, 16, 17, 18, 19 of the compensation systems 8, 9, 10, 11.

According to a non-limiting aspect 2, in the vehicle according to aspect 1 each wheel 2, 3, 4, 5 is directly connected to a single respective compensation system 8, 9, 10, 11; there are no accumulators, in particular hydraulic accumulators, between each wheel 2, 3, 4, 5 and the respective compensation system 8, 9, 10, 11.

According to a non-limiting aspect 3, the vehicle 1 according to the aspect 1 or to the aspect 2 further comprises a plurality of viscous dampers 33, each arranged between a wheel 2, 3, 4 or 5 and the respective compensation system 8, 9, 10 or 11 and/or between two different compensation systems 8, 9, 10 or 11; the viscous dampers 33 being designed to dampen any impulsive movements of a transmission fluid, determined by the variation in position of the wheels 2, 3, 4 and 5 with relative the frame 6, avoiding transmitting them directly to the hydraulic control unit 21 and/or between two different compensation systems 8, 9, 10, 11.

According to a non-limiting aspect 4, in the vehicle according to one of the aspects from 1 to 3, two hydraulic cylinders 12, 13, 14, 15, 16, 17, 18, 19 belonging to a compensation system 8, 9, 10, 11 are each connected to a hydraulic cylinder 12, 13, 14, 15, 16, 17, 18, 19 of a different compensation system 8, 9, 10, 11; each piston 20 is connected to the wheel 2, 3, 4, 5 associated with the respective compensation system 8, 9, 10, 11 so as to move depending on the variation of the position of said wheel 2, 3, 4, 5 relative to the frame 6.

According to a non-limiting aspect 5, in the vehicle according to one of the aspects from 1 to 4, the hydraulic control unit comprises a plurality of connection ducts CD, each extending from a hydraulic cylinder of one of the compensation systems 8, 9, 10, 11 to a hydraulic cylinder of another one of the compensation systems 8, 9, 10, 11; the vehicle comprises a transfer fluid, which is designed to transfer the movement between two movable pistons 20, arranged in two hydraulic cylinders 12, 13, 14, 15, 16, 17, 18, 19 of two compensation systems 8, 9, 10, 11, by moving between the two hydraulic cylinders; in particular, the transfer fluid is at least partially arranged along the connection ducts CD; more in particular, in use, the transfer fluid transfers the movement between two movable pistons 20 by flowing through one of the connection ducts CD.

According to a non-limiting aspect 6, the vehicle according to one of the aspects from 1 to 5 comprises at least one transmission cylinder 27, which is arranged, in a connected manner, between a wheel 2, 3, 4, 5 and the compensation system 8, 9, 10, 11 associated therewith; the transmission cylinder 27 is designed to transmit the variation, relative to the frame 6, of the position of the wheel 2, 3, 4, 5 to the compensation system 8, 9, 10, 11 associated therewith; in particular, the vehicle also comprises a further transmission cylinder 27′, which is fluidically connected to the transmission cylinder 27 and connects the transmission cylinder 27 to the respective compensation system 8, 9, 10, 11 so as to transmit a movement between the transmission cylinder 27 and the respective compensation system 8, 9, 10, 11; more in particular, a transmission fluid is also designed to transfer the movement of the transmission cylinder 27 and/or of the further transmission cylinder 27′ to the respective compensation system 8, 9, 10, 11.

According to a non-limiting aspect 7, in the vehicle according to one of the aspects from 1 to 6, the compensation systems 8, 9, 10, 11 comprise a first compensation system 8, a second compensation system 9, a third compensation system 10 and at least a fourth compensation system 11; a first hydraulic cylinder 12 of the first compensation system 8 is in particular fluidically connected to a first hydraulic cylinder 14 of the second compensation system 9; a second hydraulic cylinder 13 of the first compensation system 8 is in particular fluidically connected to a first hydraulic cylinder 17 of the third compensation system 10; a second hydraulic cylinder 15 of the second compensation system 9 is in particular fluidically connected to a first hydraulic cylinder 19 of the fourth compensation system 11; a second hydraulic cylinder 16 of the third compensation system 10 is in particular fluidically connected to a second hydraulic cylinder 18 of the fourth compensation system 11.

According to a non-limiting aspect 8, in the vehicle according to one of the aspects from 1 to 7, the wheels 2, 3, 4, 5 comprise a first wheel 2, a second wheel 3, a third wheel 4 and at least a fourth wheel 5; the first and third wheel 2, 4 are on a first same side of the vehicle 1; the second and fourth wheel 3, 5 are on a second same side of the vehicle 1; the first and second wheel 2, 3 are arranged in the area of a front part of the vehicle 1; the third and fourth wheels 4, 5 are arranged in the area of a rear part of the vehicle 1; the compensation system 8 associated with the first wheel 2 is directly connected to the compensation system 9, 10 associated with the second and/or third wheel 3, 4 and the compensation system 11 associated with the fourth wheel 5 is directly connected to the compensation system 9, 10 associated with the second and/or the third wheel 3, 4.

According to a non-limiting aspect 9, in the vehicle according to one of the aspects from 1 to 8 the compensation systems 8, 9, 10, 11 of two opposite wheels 2, 3, 4, 5 are indirectly connected; in particular, the control unit indirectly connects the first wheel 2 to the fourth wheel 5 and the second wheel 3 to the third wheel 4.

According to a non-limiting aspect 10, in the vehicle according to one of the aspects from 1 to 9, the pistons 20 belonging to the same compensation system 8, 9, 10, 11 are connected to one another so as to substantially move simultaneously; in particular, the pistons 20 belonging to the same compensation system 8, 9, 10, 11 are integral to one another; more in particular, they are mechanically connected by means of a rod 22.

According to a non-limiting aspect 11, in the vehicle according to one of the aspects from 1 to 10, the hydraulic cylinders 12, 13, 14, 15, 16, 17, 18, 19 belonging to the same compensation system 8, 9, 10, 11 are coaxial.

According to a non-limiting aspect 12, in the vehicle according to one of the aspects from 1 to 11, the hydraulic cylinders 12, 13, 14, 15, 16, 17, 18, 19 belonging to the same compensation system 8, 9, 10, 11 are arranged in series.

According to a non-limiting aspect 13, in the vehicle according to one of the aspects from 1 to 11, the hydraulic cylinders 12, 13, 14, 15, 16, 17, 18, 19 belonging to the same compensation system 8, 9, 10, 11 are concentric, in particular wherein the first cylinder 12, 14, 16, 18, arranged externally with respect to the second cylinder 13, 15, 17, 19, has an annular piston 20 and the second cylinder 13, 15, 17, 19, arranged internally with respect to the first cylinder 12, 14, 16, 18, has a circular piston 20.

According to a non-limiting aspect 14, in the vehicle according to one of the aspects from 1 to 10, the hydraulic cylinders 12, 13, 14, 15, 16, 17, 18, 19 belonging to the same compensation system 8, 9, 10, 11 are arranged in parallel.

According to a non-limiting aspect 15, in the vehicle according to one of the aspects from 1 to 14, the hydraulic cylinders 12, 13, 14, 15 of the compensation systems 8, 9 associated with the wheels 2, 3 arranged in the area of a front part of the vehicle 1 have pistons 20 with a pushing surface that is different from the one of the hydraulic cylinders 16, 17, 18, 19 of the compensation systems 10, 11 associated with the wheels 4, 5 arranged in the area of a rear part of the vehicle 1; in particular, the hydraulic cylinders 12, 13, 14, 15 of the compensation systems 8, 9 associated with the wheels 2, 3 arranged in the area of the front part have pistons 20 with a greater pushing surface than the pistons 20 of the hydraulic cylinders 16, 17, 18, 19 of the compensation systems 10, 11 associated with the wheels 4, 5 arranged in the area of a rear part.

According to a non-limiting aspect 16, the vehicle according to one of the aspects from 1 to 15 comprises at least a first attitude corrector 23 and a second attitude corrector 23; the first and second attitude corrector 23 are designed to lift or lower the land vehicle 1 at the front and at the back, respectively.

According to a non-limiting aspect 17, in the vehicle according to one of the aspects from 1 to 16, the compensation system 8, 9, 10, 11 comprises a suspension 24; which comprises a dashpot 25 and/or a damping system 26 chosen in the group consisting of: a spring, a pneumatic suspension or a combination thereof.

According to a non-limiting aspect 18, in the vehicle according to one of the aspects from 1 to 17, each viscous damper 33 comprises one or more blades 47, which bend under the thrust of a transmission fluid allowing the transmission fluid to flow through the viscous damper 33.

According to a non-limiting aspect 19, the vehicle according to one of the aspects from 1 to 18 comprising a plurality of hydraulic filters 34, which are each arranged between a wheel 2, 3, 4 or 5 and the respective compensation system 8, 9, 10 or 11 and/or between two different compensation systems 8, 9, 10 or 11, in particular, the hydraulic filters 34 are low-pass filters designed to reduce in particular stop, in case of undesired frequencies, the flow of the fluid transmission and therefore the association between the wheel 2, 3, 4 or 5 and the respective compensation system 8, 9, 10 or 11 and/or between two different compensation systems 8, 9, 10, 11.

According to a non-limiting aspect 20, in the vehicle according to one of the aspect 19 the hydraulic filters 34 each comprise: a main body 37 which mechanically connects a first duct 35 to a second duct 36 and delimits a filtering chamber 38; a movable mass 39, which is movable along a conveying direction D, arranged inside the filtering chamber 38 and capable of assuming a plurality of positions along the conveying direction D based on the direction of the transmission fluid; at least one passage channel 40, 41, inside the filtering chamber 38, through which the transmission fluid flows; a shutter 42 which is arranged inside the filtering chamber 38, mounted movable relative to the mass 39, and capable of assuming: at least a first disengagement position, which allows the transmission fluid to flow from the first duct 35 to the second duct 36 through the at least one passage channel 40, 41; at least a second disengagement position, which allows the transmission fluid to flow from the second duct 36 to the first duct 35 through the at least one passage channel 40, 41; and at least a blocking position, which prevents the fluid from flowing through by blocking the passage channel 40, 41; and at least one elastic element 43, which mechanically connects the shutter 42 and the mass 39, so that the shutter 42 follows the movements of the movable mass 39 with a delay.

According to a further non-limiting aspect 21 of the present invention, a hydraulic filter 34 is provided to reduce, in particular to stop, the flow of a fluid between a first duct 35 and a second duct 36 in case of resonant movements of the fluid; the hydraulic filter 34 comprises: a main body 37 which mechanically connects the first duct 35 to the second duct 36 and delimits a filtering chamber 38; a movable mass 39, which is movable along a conveying direction D, arranged inside the filtering chamber 38 and capable of assuming a plurality of positions along the conveying direction D based on the direction of the fluid; at least one passage channel 40, 41, inside the filtering chamber 38, through which the fluid flows; a shutter 42 arranged inside the filtering chamber 38, mounted movable relative to the mass 39, and capable of assuming: at least a first disengagement position, which allows the fluid to flow from the first duct 35 to the second duct 36 through the at least one passage channel 40, 41; at least a second disengagement position, which allows the fluid to flow from the second duct 36 to the first duct 35 through the at least one passage channel 40, 41; and at least a blocking position, which prevents the fluid from flowing through by blocking the passage channel 40, 41; and at least one elastic element 43, which mechanically connects the shutter 42 and the mass 39, so that the shutter 42 follows the movements of the movable mass 39 with a delay.

According to a non-limiting aspect 22, in the filter 34 according to the aspect 21 the elastic element 43 comprises a spring.

According to a non-limiting aspect 23, in the filter 34 according to one of the aspects 21 or 22 the stiffness of the elastic element 43 determines the frequency of the resonant movements of the fluid at which the shutter 42 stops in the blocking position or positions.

According to a non-limiting aspect 24, in the filter 34 according to one of the aspects from 21 to 23 the shutter 42 is arranged between the movable mass 39 and an inner side wall 44 of the passage channel 40, 41.

According to a non-limiting aspect 25, in the filter 34 according to the aspect 24 the shutter 42, the movable mass 39 and the inner side wall 44 of the passage channel 40, 41 are at least partially coaxial.

According to a non-limiting aspect 26, the filter 34 according to one of the aspects from 21 to 25 comprises fluid direction selection devices 45, in particular two rings, arranged at the ends of the filtering chamber 38, in particular at the first and the second duct 35, 36.

According to a further non-limiting aspect 27 according to the present invention, a land vehicle 1 is provided comprising: a frame 6; at least four wheels 2, 3, 4, 5; and at least four compensation systems 8, 9, 10, 11 each associated with a respective wheel 2, 3, 4, 5; wherein each compensation system 8, 9, 10, 11 comprises at least two hydraulic cylinders 12, 13, 14, 15, 16, 17, 18, 19, and at least two pistons 20, each arranged inside a relative cylinder 12, 13, 14, 15, 16, 17, 18, 19; wherein each cylinder 12, 13, 14, 15, 16, 17, 18, 19 and the relative piston 20 arranged inside the cylinder 12, 13, 14, 15, 16, 17, 18, 19 are mounted so that they can move relative to one another; at least one between each cylinder 12, 13, 14, 15, 16, 17, 18, 19 and the relative piston 20 is connected to the wheel 2, 3, 4, 5 associated with the respective compensation system 8, 9, 10, 11 so as to move depending on the variation of the position of said wheel 2, 3, 4, 5 relative to the frame 6; the vehicle 1 further comprises a control unit 21, in particular a hydraulic control unit, which comprises the compensation systems 8, 9, 10, 11 and connects each wheel 2, 3, 4, 5 to the other wheels 2, 3, 4, 5 by means of the hydraulic cylinders 12, 13, 14, 15, 16, 17, 18, 19 of the compensation systems 8, 9, 10, 11; the vehicle 1 further comprises a plurality of hydraulic filters 34 according to the preceding claims, which are each arranged between a wheel 2, 3, 4 or 5 and the respective compensation system 8, 9, 10 or 11 and/or between two different compensation systems 8, 9, 10 or 11, in particular, the hydraulic filters 34 are low-pass filters designed to stop the association between the wheel 2, 3, 4 or 5 and the respective compensation system 8, 9, 10 or 11 and/or between two different compensation systems 8, 9, 10, 11 in case of undesired frequencies.

The land vehicle 1 according to the present invention therefore has many advantages.

First of all, it makes it possible to guarantee the safety and comfort of passengers on board the land vehicle 1 itself. In particular, by actively compensating the torsional forces that the frame 6 of a land vehicle 1 undergoes while travelling on an impervious or rough stretch and by actively controlling the front, rear and side attitude of the vehicle on the basis of the path being travelled, to travel on rough or sloping roads, whereas this is not possible according to the solutions of the known art.

Furthermore, if the vehicle 1 is a high-performance sports car, the present invention allows to improve its performance by avoiding energy dispersions on the frame and to increase its reliability by avoiding excessive or prolonged torsions of the frame. In addition, the object of the present invention allows to improve the road grip by keeping the force exerted by each wheel on the ground more constant.

In addition, by using viscous dampers, the free oscillations of the elastic system with a degree of freedom are prevented. In addition, the stiffness and performance of the land vehicle are maintained (differently from the case in which hydraulic accumulators are used), while the use of hydraulic filters simultaneously safeguards the safety and comfort of the passengers.

A further advantage of the present invention lies in the fact that the transmission cylinders allow to optimize the location of the hydraulic control unit (optimizing the volumes in a concentrated area), avoiding the need to insert a plurality of hydraulic cylinders in proximity to the suspensions (zones of the vehicle which themselves have a restricted possibility of inserting bulky elements). In this way, it is possible to avoid the use of two connection points (present in the case with the cylinders in parallel) between the compensation system and the respective wheel. Furthermore, it avoids having to increase the mass of the connection elements to make them sufficiently rigid and allow the two cylinders to move simultaneously. In addition, the presence of the transmission cylinders allows (in the case of the cylinders in series) to maintain the ratio between the travel of the suspension (shock absorber) and the wheel similar to 1:1, avoiding the need to insert cylinders with an overall length of at least twice the travel of the wheel (for a 30 cm travel of the wheel, a length of 60 cm of the compensation system would be necessary (the cylinders being in series). In addition, the presence of the transmission cylinders allows the compensation systems to be installed also on a standard vehicle (or as an option).

Finally, it is possible to activate or deactivate, through the hydraulic pump, the hydraulic control unit in case of a malfunction or a fault (also external to the control unit itself such as the loss of pressure of a tire).

1. A land vehicle comprising:
a frame; at least four wheels; and at least four compensation systems, each associated with a respective wheel;
the land vehicle being characterized in that
each compensation system comprises at least two hydraulic cylinders and at least two pistons, each arranged inside a relative cylinder;
each cylinder and the relative piston arranged inside the cylinder are mounted so that they can move relative to one another; at least one between each cylinder and the relative piston is connected to the wheel associated with the respective compensation system so as to move depending on the variation of the position of said wheel relative to the frame;
the vehicle further comprises a control unit, in particular a hydraulic control unit, which comprises the compensation systems and connects each wheel to the other wheels by means of the hydraulic cylinders of the compensation systems;
the vehicle further comprises a plurality of hydraulic filters, which are each arranged between a wheel and the respective compensation system and/or between two different compensation systems, the hydraulic filters are low-pass filters designed to reduce (in particular stop), in case of undesired frequencies, the flow of a transmission fluid and, hence, the association between the wheel and the respective compensation system and/or between two different compensation systems;
the vehicle comprising at least one transmission cylinder, which is arranged, in a connected manner, between a wheel and the compensation system associated therewith; the transmission cylinder is designed to transmit the variation, relative to the frame, of the position of the wheel to the compensation system associated therewith; in particular, the vehicle also comprises a further transmission cylinder, which is fluidically connected to the transmission cylinder and connects the transmission cylinder to the respective compensation system so as to transmit a movement between the transmission cylinder and the respective compensation system; more in particular, the transmission fluid is designed to transfer the movement of the transmission cylinder and/or of the further transmission cylinder to the respective compensation system.

2. A vehicle according to claim 1, wherein two hydraulic cylinders belonging to a compensation system are each connected to a hydraulic cylinder of a different compensation system; each piston is connected to the wheel associated with the respective compensation system so as to move depending on the variation of the position of said wheel relative to the frame; the hydraulic control unit comprises a plurality of connection ducts, each extending from a hydraulic cylinder of one of the compensation systems to a hydraulic cylinder of another one of the compensation systems; the vehicle comprises a transfer fluid, which is designed to transfer the movement between two movable pistons, arranged in two hydraulic cylinders of two compensation systems, by moving between the two hydraulic cylinders; in particular, the transfer fluid is at least partially arranged along the connection ducts; more in particular, in use, the transfer fluid transfers the movement between two movable pistons by flowing through one of the connection ducts.

3. A vehicle according to claim 1, wherein the compensation systems comprise a first compensation system, a second compensation system, a third compensation system and at least a fourth compensation system; a first hydraulic cylinder of the first compensation system is (in particular, fluidically) connected to a first hydraulic cylinder of the second compensation system; a second hydraulic cylinder of the first compensation system is (in particular, fluidically) connected to a first hydraulic cylinder of the third compensation system; a second hydraulic cylinder of the second compensation system is (in particular, fluidically) connected to a first hydraulic cylinder of the fourth compensation system; a second hydraulic cylinder of the third compensation system is (in particular, fluidically) connected to a second hydraulic cylinder of the fourth compensation system.

4. A vehicle according to claim 1, wherein the wheels comprise a first wheel, a second wheel, a third wheel and at least a fourth wheel; the first and the third wheel are on a same first side of the vehicle; the second and the fourth wheel are on a same second side of the vehicle; the first and the second wheel are arranged in the area of a front part of the vehicle; the third and fourth wheel are arranged in the area of a rear part of the vehicle; the compensation system associated with the first wheel is directly connected to the compensation system associated with the second and/or the third wheel and the compensation system associated with the fourth wheel is directly connected to the compensation system associated with the second and/or the third wheel; the compensation systems of two opposite wheels are indirectly connected; in particular, the control unit indirectly connects the first wheel to the fourth wheel and the second wheel to the third wheel.

5. A vehicle according to claim 1, wherein the pistons belonging to the same compensation system are connected to one another so as to substantially move simultaneously; in particular, the pistons belonging to the same compensation system are integral to one another; more in particular, they are mechanically connected by means of a rod.

6. A vehicle according to claim 1, wherein the hydraulic cylinders belonging to the same compensation system are coaxial.

7. A vehicle according to claim 1, wherein the hydraulic cylinders belonging to the same compensation system are arranged in series.

8. A vehicle according to claim 1, wherein the hydraulic cylinders belonging to the same compensation system are arranged in parallel.

9. A vehicle according to claim 1, wherein the hydraulic cylinders of the compensation systems associated with the wheels arranged in the area of a front part of the vehicle have pistons with a pushing surface that is different from the one of the hydraulic cylinders of the compensation systems associated with the wheels arranged in the area of a rear part of the vehicle; in particular, the hydraulic cylinders of the compensation systems associated with the wheels arranged in the area of the front part have pistons with a greater pushing surface than the pistons of the hydraulic cylinders of the compensation systems associated with the wheels arranged in the area of a rear part.

10. A vehicle according to claim 1 and comprising a first attitude corrector and a second attitude corrector; the first and the second attitude corrector are designed to lift or lower the land vehicle at the front and at the back, respectively; the compensation system comprises a suspension, which comprises a further dashpot and/or a damping system chosen in the group consisting of: a spring, a pneumatic suspension or a combination thereof.

11. A vehicle according to claim 1, wherein the hydraulic filters each comprise:
a main body, which mechanically connects a first duct to a second duct and delimits a filtering chamber;
a movable mass, which is movable along a conveying direction, is arranged inside the filtering chamber and is capable of assuming a plurality of positions along the conveying direction based on the direction of the transmission fluid;
at least one passage channel inside the filtering chamber, through which the transmission fluid flows;
a shutter, which is arranged inside the filtering chamber, is movable relative to the mass and is capable of assuming: at least a first disengagement position, which allows the transmission fluid to flow from the first duct to the second duct through said at least one passage channel; at least a second disengagement position, which allows the transmission fluid to flow from the second duct to the first duct through said at least one passage channel; and at least a blocking position, which prevents the transmission fluid from flowing through by obstructing the passage channel; and
at least one elastic element, in particular comprising a spring, which mechanically connects the shutter and the mass, so that the shutter follows the movements of the movable mass with a delay.

12. A vehicle according to claim 11, wherein the stiffness of the elastic element determines the frequency of the resonant movements of the fluid at which the shutter stops in the blocking position(s).

13. A vehicle according to claim 11, wherein the shutter is arranged between the movable mass and an inner side wall of the passage channel; in particular, the shutter, the movable mass and the inner side wall of the passage channel are at least partially coaxial.

14. A vehicle according to claim 11 comprising fluid direction selection devices, in particular two rings, arranged at the ends of the filtering chamber, in particular in the area of the first and of the second duct.

15. A vehicle according to claim 1, wherein each wheel is directly connected to one single respective compensation system and wherein there are no accumulators, in particular hydraulic accumulators, between the wheel and the respective compensation system.
